(19) United States
(12) Patent Application Publication
(10) Pub. No.: US 2007/0221254 A1
(43) Pub. Date: Sep. 27, 2007

(54) SUBSTRATE PROCESSING APPARATUS AND SUBSTRATE PROCESSING METHOD

(76) Inventors: Akira Izumi, Kyoto (JP); Hideaki Matsubara, Kyoto (JP); Naozumi Fujiwara, Kyoto (JP); Katsuhiko Miya, Kyoto (JP)

Correspondence Address: OSTROLENK FABER GERB & SOFFEN, 1180 AVENUE OF THE AMERICAS, NEW YORK, NY, 100368403, US

(21) Appl. No.: 11/687,934

(22) Filed: Mar. 19, 2007

(30) Foreign Application Priority Data
Mar. 24, 2006 (JP) 2006-082085
Dec. 21, 2006 (JP) 2006-343960

(51) Int. Cl. B08B 3/00

(52) U.S. Cl. 134/26; 134/94.1

(57) ABSTRACT

Substrates having liquid films with preprocessing liquid on surfaces thereof in a preprocessing unit are transported to a freezing unit arranged separately from the preprocessing unit by a substrate transporting robot. In the freezing unit, the substrates are accommodated in a processing space in a processing chamber and the liquid films are frozen by decreasing the temperature of the processing space to a temperature below the freezing point of the preprocessing unit. Subsequently, the substrates subjected to the freezing process are transported from the freezing unit to a post-processing unit arranged separately from the freezing unit. In the post-processing unit, cleaning liquid is supplied to frozen films, whereby contaminants having adhesive forces to the substrate reduced by the freezing process can be easily removed together with the frozen film.

### CROSS REFERENCE TO RELATED APPLICATION

The disclosure of Japanese Patent Applications enumerated below including specification, drawings and claims is incorporated herein by reference in its entirety:

No. 2006-82085 filed Mar. 24, 2006; and

No. 2006-343960 filed Dec. 21, 2006.

### BACKGROUND OF THE INVENTION

1. Field of the Invention

The present invention relates to a substrate processing apparatus and a substrate processing method for cleaning substrates of various types (hereinafter called simply “substrates”) such as semiconductor wafers, glass substrates for photomasks, glass substrates for liquid crystal displays, glass substrates for plasma displays and substrates for optical disks.

2. Description of the Related Art

With the miniaturization, higher functionalization and higher precision of devices typified by semiconductor devices, it becomes increasingly difficult to remove fine contaminants such as foreign substances and particles adhering to a surface of a substrate without destroying patterns formed on the surface of the substrate. As a solution to this problem, following cleaning method has been proposed. In this method, a liquid film is first formed on the substrate by applying liquid to the substrate. Subsequently, the liquid film is frozen on the substrate so that the contaminants adhering to the substrate separate from the surface of the substrate. Finally, the liquid film (frozen film) after the freezing is removed from the substrate, whereby the contaminants are easily removed from the substrate (see JP-A-11-31673, JP-T-3-503975, JP-A-3-261142, U.S. Pat. No. 6,783,599 and JP-A-62-169420).

### SUMMARY OF THE INVENTION

Incidentally, for executing the cleaning processes described above (liquid film forming step+freezing step+film removal step), a liquid film is formed on a surface of a substrate by supplying liquid to the substrate as a preprocessing after the substrate is placed in a processing chamber. Thereafter, the liquid film is frozen, for example, by feeding chilling gas into the chamber. Further, in order to remove the frozen liquid film (frozen film), the frozen film is defrosted and removed, for example, by supplying liquid such as warm water to the substrate in the same chamber as a post-processing.

However, in the case of executing the cleaning process in the same processing chamber as described above, there have been cases where the following problems occur. Specifically, not only the substrate, but also space where the substrate is placed (processing space) is cooled upon freezing the liquid film, and hence, not only the substrate, but also the processing space accumulates cold. Thus, in order to defrost and remove the frozen film from the substrate, it has been necessary to increase not only the temperature of the substrate, but also that of the processing space. Particularly in the case of accommodating a plurality of substrates in the processing chamber, the volume of the processing space defined inside the processing chamber also increases. Further, the freezing process is often performed by decreasing the temperature of the processing space to a temperature below the freezing point of the liquid forming the liquid film and, in such cases, the quantity of cold accumulated in the processing space increases. Therefore, upon defrosting the frozen film, considerable amounts of thermal energy and time have been needed to increase the temperature of the processing space.

Further, in the production process, a series of cleaning processes need to be continuously performed. In this case, the freezing process and the defrosting process are repeatedly performed. At this time, when the freezing process and the defrosting process are repeatedly performed in the same processing chamber, this results in a thermal cycle of decreasing the temperature of the processing space until the liquid film is frozen and increasing it until the frozen film is defrosted in the processing space. This leads not only to poor thermal energy efficiency, but also to difficulty to stabilize the temperature of the processing space to those suitable for the respective freezing process and defrosting process. Furthermore, such a problem becomes more notable as the volume of the processing space increases particularly as in the case where a plurality of substrates are accommodated in the processing space, and has been a big obstacle in improving the process efficiency of the cleaning process.

The invention has been made in light of the problems described above, and an object thereof is to provide a substrate processing apparatus and a substrate processing method that are capable of improving the process efficiency of a cleaning process while satisfactorily cleaning a substrate.

According to a first aspect of the present invention, there is provided a substrate processing apparatus which cleans a substrate, comprising: a preprocessing unit which supplies preprocessing liquid to the substrate and forms a liquid film of the preprocessing liquid on a surface-to-be-processed of the substrate, a freezing unit which includes a processing chamber in which a processing space capable of accommodating the substrate and freezes the liquid film formed on the surface-to-be-processed of the substrate by decreasing the temperature of the processing space to a temperature below the freezing point of the preprocessing liquid, a post-processing unit which supplies post-processing liquid to the liquid film after the freezing and removes the liquid film from the surface-to-be-processed of the substrate, and a transporting section which transports the substrate between the preprocessing unit and the freezing unit and between the freezing unit and the post-processing unit inside the apparatus out of the three processing units arranged separately from each other inside the apparatus.

According to a second aspect of the present invention, there is provided a substrate processing method for cleaning a substrate, comprising: a liquid film forming step of applying preprocessing liquid to a surface-to-be-processed of the substrate to form a liquid film with the preprocessing liquid in a preprocessing unit; a first transporting step of transporting the substrate on which the liquid film is formed with the preprocessing liquid to a freezing unit which is arranged separately from the preprocessing unit and which includes a processing chamber in which a processing space capable of accommodating the substrate is formed; a freezing step of freezing the liquid film by decreasing the temperature of the processing space to a temperature below the freezing point of the preprocessing liquid in the freezing unit; a second transporting step of transporting the substrate having the liquid film frozen in the freezing unit to a post-processing unit arranged separately from the freezing unit; and a film removal step of removing the frozen film by supplying post-processing liquid to the surface-to-be-processed of the substrate in the post-processing unit.

In the context of the invention, a “surface-to-be-processed” means a surface which needs be subjected to cleaning process. In the case where it is necessary to perform cleaning process to one of the principal surfaces of the substrate on which a device pattern and the like is formed, this principal surface corresponds to the “surface-to-be-processed” of the invention. Further, in the case where it is necessary to perform cleaning process to the other principal surface, the other principal surface corresponds to a “surface-to-be-processed” of the invention. Of course, in the case where it is necessary to perform cleaning process to both of the principal surfaces as in the case of a double-sided mounted substrate, both of the principal surfaces correspond to a “surface-to-be-processed” of the invention.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1 is a perspective view showing a first embodiment of a substrate processing apparatus according to the present invention.

FIG. 2 is a block diagram showing a main control construction of the substrate processing apparatus shown in FIG. 1.

FIG. 3 is a diagram showing a construction of the preprocessing unit equipped in the substrate processing apparatus shown in FIG. 1.

FIG. 4 is a diagram showing a construction of the freezing unit equipped in the substrate processing apparatus shown in FIG. 1.

FIG. 5 is a diagram showing a construction of the post-processing unit equipped in the substrate processing apparatus shown in FIG. 1.

FIG. 6 is a flow chart showing the operation of the substrate processing apparatus shown in FIG. 1.

FIG. 7 is a diagram showing a modification of the preprocessing unit.

FIG. 8 is a diagram showing a modification of the post-processing unit.

FIG. 9 is a diagram showing another modification of the post-processing unit.

FIG. 10 is a partial enlarged view of the substrate holding guide equipped in the freezing unit.

FIG. 11 is a plan layout diagram of a substrate processing apparatus of a second embodiment.

FIG. 12 is a block diagram showing a main control construction of the substrate processing apparatus shown in FIG. 11.

FIG. 13 is a diagram showing a construction of the wet processing unit equipped in the substrate processing apparatus shown in FIG. 11.

FIG. 14 is a diagram showing a construction of the freezing unit.

FIG. 15 is a plan view of a cooling plate disposed in the freezing unit shown in FIG. 14.

FIG. 16 is a flow chart showing the operation of the substrate processing apparatus shown in FIG. 11.

FIGS. 17A, 17B and 17C are diagrams showing the freezing process and an operation of unloading the substrate after the freezing process in the freezing unit shown in FIG. 14.

FIG. 18 is a diagram showing a construction of a freezing unit equipped in a substrate processing apparatus according to a third embodiment.

FIG. 19 is a diagram showing a construction of a freezing unit equipped in a substrate processing apparatus according to a fourth embodiment.

FIG. 20 is a partial enlarged diagram of the boat equipped in the freezing unit shown in FIG. 19.

FIG. 21 is a diagram showing a construction of a freezing unit equipped in a substrate processing apparatus according to a fifth embodiment.

FIG. 22 is a partial enlarged diagram of a boat equipped in the freezing unit shown in FIG. 21.

FIG. 23 is a plan view of a susceptor.

FIGS. 24A, 24B and 24C are diagrams showing a freezing process and an operation of unloading the substrate after the freezing process in the freezing unit shown in FIG. 21.

### DETAILED DESCRIPTION OF THE PREFERRED EMBODIMENTS

### First Embodiment

A. Overall Construction of Substrate Processing Apparatus

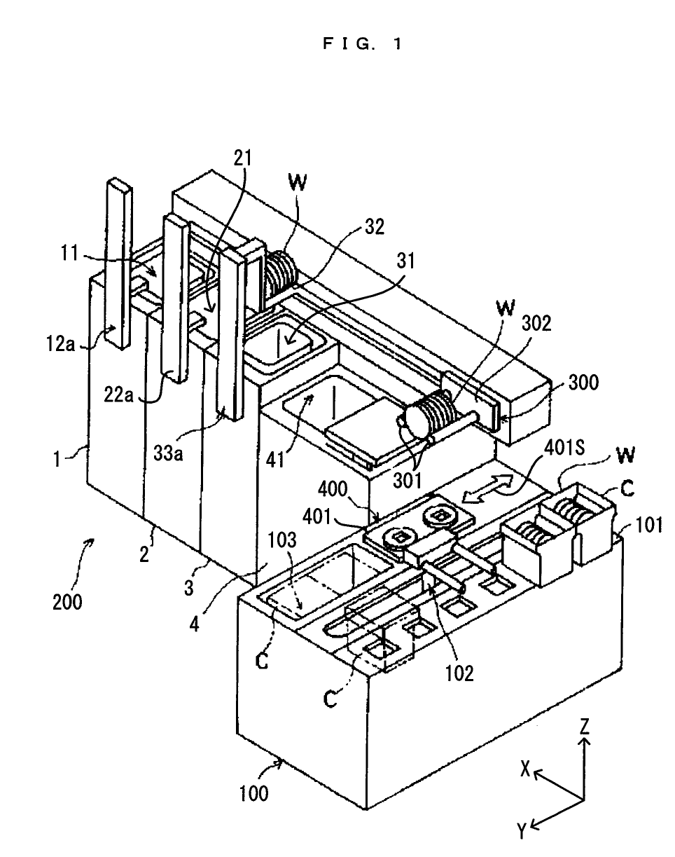

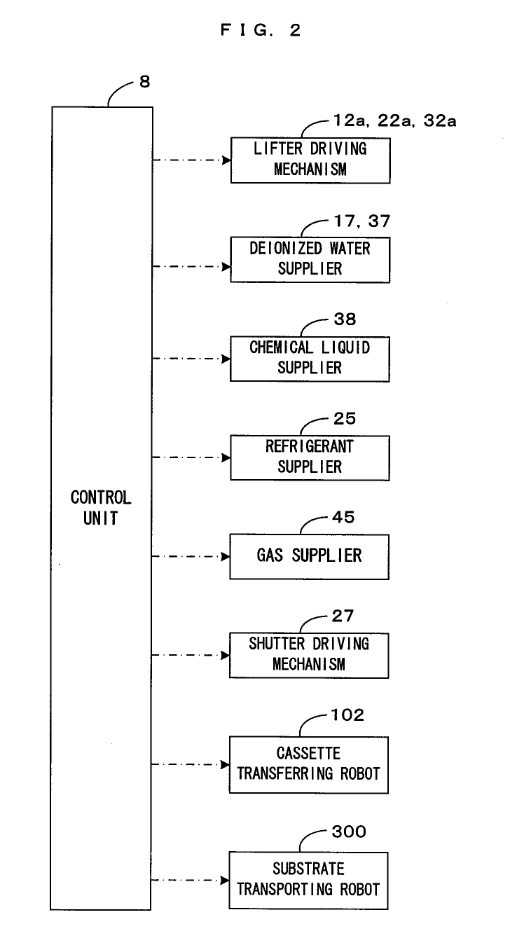

FIG. 1 is a perspective view showing a first embodiment of a substrate processing apparatus according to the present invention, and FIG. 2 is a block diagram showing a main control construction of the substrate processing apparatus shown in FIG. 1. This substrate processing apparatus is a batch type substrate processing apparatus that is used for the cleaning processes for the purpose of removing contaminants such as particles and various types of metallic impurities adhering to surfaces (corresponding to “surface-to-be-processed” in the invention) of substrates W such as semiconductor wafers. More specifically, this is an apparatus which removes contaminants together with frozen films by applying preprocessing liquid to the substrate surfaces, on which device patterns are formed, to thereby form films of the preprocessing liquid, and then freezing the liquid films and supplying post-processing liquid to the liquid films after freezing (frozen films).

This substrate processing apparatus roughly includes a cassette placing section 100, a cleaning section 200 which cleans the substrates W, a substrate transporting robot 300 which transports the substrates W between the cassette placing section 100 and the cleaning section 200, and a substrate transferring section 400 which is a substrate transferring apparatus. It should be noted that XYZ coordinate systems are shown in FIG. 1 in order to clarify directional relationship.

The cassette placing section 100 includes a cassette placing area 101 into which cassettes C are loaded from the outside of the apparatus and on which the cassettes C are placed, a cassette transferring robot 102 which transfers the cassettes C, and a cassette cleaning mechanism 103 which cleans the cassettes C. The cassette transferring robot 102 transfers the cassettes C to the substrate transferring section 400 at a suitable timing after the cassettes C accommodating unprocessed substrates W are loaded from the outside of the apparatus into the cassette placing area 101. This cassette transferring robot 102 also transfers the cassettes C accommodating the processed substrates W and placed on the substrate transferring section 400 to the cassette placing area 101. It should be noted that the cassettes C returned to the cassette placing area 101 in this way are transported to a next processing apparatus.

The substrate transferring section 400 includes a cassette placing table 401 constructed such that two cassettes C can be placed thereon, and hence, it is possible to receive two cassettes C from the cassette transferring robot 102. The cassette placing table 401 is made movable in Y-direction as shown by arrows 401S in FIG. 1 by a movement driving source (not shown), and enables the two cassettes C placed thereon to rotate about an axis extending in Z-direction. The unprocessed substrates W are thrust upward (in Z-direction) from the respective cassettes C and all the unprocessed substrates W in the two cassettes C are transferred to the substrate transporting robot 300. Further, the processed substrates W held by the substrate transporting robot 300 are divided and transferred to the two cassettes C.

The substrate transporting robot 300 having received the unprocessed substrates W from the cassettes C via the substrate transferring section 400 causes a series of batch processes to be applied to the substrates W by successively transporting the substrates W to a pre-processing unit 1 which performs a preprocessing, a freezing unit 2 which performs a freezing process, a post-processing unit 3 which performs a post-processing and a drying unit 4 which dries the substrates W, the units 1 to 4 constructing the cleaning section 200, and then transfers the processed substrates W to the cassettes C in the substrate transferring section 400. It should be noted that these cassettes C are returned to the cassette placing area 101 by the cassette transferring robot 102.

The preprocessing unit 1, the freezing unit 2, the post-processing unit 3 and the drying unit 4 constructing the cleaning section 200 are arranged separately from each other inside the substrate processing apparatus. The substrate transporting robot 300 transports the substrates W between the preprocessing unit 1 and the freezing unit 2 and between the freezing unit 2 and the post-processing unit 3 in the apparatus in accordance with an operation command from a control unit 8 which controls the entire apparatus, whereby a series of cleaning processes (liquid film forming step+freezing step+film removal step) are performed in the apparatus. Further, the substrate transporting robot 300 transports the substrates W between the post-processing unit 3 and the drying unit 4 in the apparatus, whereby the substrates W after the cleaning process can be dried. In this way, the substrate transporting robot 300 functions as “transporting section” of the present invention according to this embodiment.

This substrate transporting robot 300 has a pair of holding posts 301 which are movable in X-direction and extend in Y-direction. The substrates W can be held in upright posture by having the outer peripheries thereof held by these holding posts 301. Further, the holding posts 301 are connected to a main body 302 (holder driving source) of the substrate transporting robot 300 and is rotatable about an axis extending in Y-direction by the main body 302. A side surface of each holding post 301 is divided into a plurality of holding surfaces in circumferential direction centered on the axis (Y-direction axis) of the holding post 301, and a plurality of grooves which hold a plurality of substrates W in upright posture are formed in Y-direction in the respective holding surfaces. Thus, the holding surfaces can be switched by turning the holding posts 301 in conformity with the surface states of the substrates and the like.

Although one each of the preprocessing unit 1, the freezing unit 2, the post-processing unit 3 and the drying unit 4 is arranged in the cleaning section 200 in this embodiment, the number of each processing unit and the arranged positions thereof are not limited thereto. Specifically, a plurality of processing units may be arranged in conformity with a processing tact according to needs. Likewise, a plurality of substrate transporting robots 300 may be arranged so that, while one substrate transporting robot transports a plurality of substrates W from the preprocessing unit 1 to the freezing unit 2, the other substrate transporting robot transports a plurality of other substrates W from the post-processing unit 3 to the drying unit 4. Furthermore, the same processing unit may be arranged in the cleaning section 200 and the liquid film forming process by preprocessing liquid and the film removal process by post-processing liquid may be performed in this processing unit by using common processing liquid as the preprocessing liquid and the post-processing liquid and commonly using the constructions of the preprocessing unit 1 and the post-processing unit 3 in part or entirely.

B. Construction of the Cleaning Section

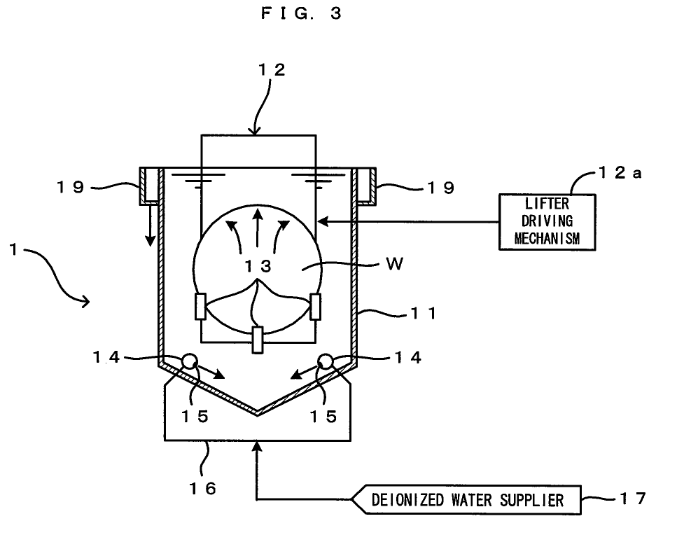

Next, the preprocessing unit 1 is described with reference to FIG. 3. FIG. 3 is a diagram showing a construction of the preprocessing unit 1 equipped in the substrate processing apparatus shown in FIG. 1. This preprocessing unit 1 performs a process (preprocessing) which forms liquid films on surfaces of substrates by supplying preprocessing liquid to the substrate. The preprocessing unit 1 includes a processing tank (corresponding to a “first processing tank” of the present invention) 11 which stores deionized water as “preprocessing liquid” of the present invention. Substrates W such as semiconductor wafers are loaded into the processing tank 11 to be accommodated therein, and subjected to the preprocessing in the processing tank 11. A lifter 12 which accommodates a plurality of substrates W in upright posture is disposed in the processing tank 11. This lifter 12 is free to move upward and downward between an inner position (position shown in FIG. 3) in the processing tank 11 and an upper position above the processing tank 11, and is driven to elevate by a lifter driving mechanism 12a. The lifter 12 includes three substrate holding guides 13 which hold a plurality of substrates W. A plurality of notch-shaped holding grooves engageable with parts of peripheral edge portions of the substrates W are formed to hold the substrates W in the three substrate holding guides 13 while being arranged at specified intervals in a longitudinal direction (direction normal to the surfaces of the substrates W).

Two tubular processing liquid supply nozzles 14 are arranged substantially in a horizontal direction near the inner bottom of the processing tank 11. A plurality of discharge holes 15 for discharging the preprocessing liquid (deionized water) are formed in each processing liquid supply nozzle 14. Further, the respective processing liquid supply nozzles 14 are communicated with a deionized water supplier 17 via a processing liquid supply pipe 16, so that deionized water is supplied from the respective processing liquid supply nozzles 14 to the processing tank 11 when deionized water is pressure fed from the deionized water supplier 17 in accordance with an operation command from the control unit 8. The deionized water discharged from the respective processing liquid supply nozzles 14 at both left and right sides overflows through an opening at the top of the tank while forming an upward flow in the middle of the tank. Then, contaminants dispersed in the deionized water are collected together with the overflowed deionized water into an overflow tank 19 and discharged to the outside of the tank.

Thus constructed, when the lifter driving mechanism 12a is driven for downward movement in accordance with an operation command from the control unit 8, the lifter 12 accommodating a plurality of substrates W is moved downward from the upper position. Thus, a plurality of substrates W are simultaneously immersed into the deionized water stored in the processing tank 11. When the lifter driving mechanism 12a is driven for upward movement and the lifter 12 is moved upward thereafter, a plurality of substrates W are pulled up from the deionized water stored in the processing tank 11. In this way, the deionized water adheres to the respective surfaces of a plurality of substrates W, whereby liquid films (water films) can be collectively formed on the surfaces of these substrates W. Thus, the lifter driving mechanism 12a functions as an “immersing and pulling-up section” of the present invention according to this embodiment.

It should be noted that mixture of deionized water and surface-active agent may be used as the preprocessing liquid. By using such a preprocessing liquid, even if contaminants adhering to the substrate surfaces are microscopic particles, the wettability of particle surfaces is improved so that the preprocessing liquid can securely intrude even into small clearances between the substrates W and the particles. This can promote the separation of the contaminants adhering to the substrate surfaces from the substrate surfaces upon freezing the liquid films in the freezing process to be described later. In order to add the surface-active agent to the deionized water as described above, the surface-active agent may be mixed into the deionized water beforehand and this mixture liquid may be supplied from the processing liquid supply nozzles 14 to the processing tank 11.

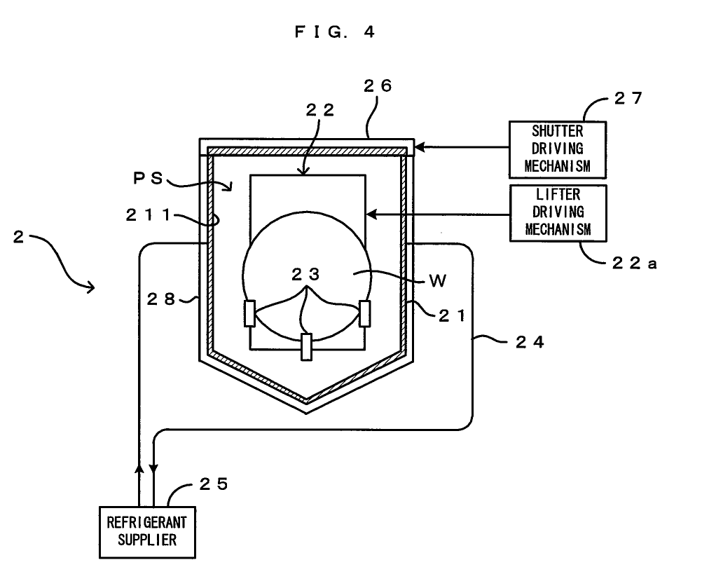

Next, the freezing unit 2 is described with reference to FIG. 4. FIG. 4 is a diagram showing a construction of the freezing unit 2 equipped in the substrate processing apparatus shown in FIG. 1. This freezing unit 2 performs a process (freezing process) for freezing the liquid films formed on the substrate surfaces. The freezing unit 2 includes a processing tank 21 as a “processing chamber” of the present invention. In the processing tank 21, a processing space PS capable of accommodating a plurality of substrates W is formed. The size of the processing tank 21 may be set equal to those of the processing tank 11 provided in the preprocessing unit 1 and a processing tank 31 provided in the post-processing unit 3 to be described later or may be exclusively set to a specified size suitable to freeze the liquid films upon performing the freezing process. A lifter 22 is so disposed in the freezing unit 2 as to be movable upward and downward between an inner position (position shown in FIG. 4) in the processing tank 21 and an upper position above the processing tank 21, and is driven to elevate by a lifter driving mechanism 22a. Thus, a plurality of substrates W can be placed at the upper position above the processing tank 21 and the position accommodated in the processing space PS while being held by substrate holding guides 23 which the lifter 22 has.

An inner wall surface 211 of the processing tank 21 is a cooling surface which cools the processing space PS, and a refrigerant path 24 is formed along the inner wall surface 211 so as to surround the processing space PS. The opposite ends of this refrigerant path 24 are connected to a refrigerant supplier 25. The refrigerant supplier 25 includes a cooler which cools the refrigerant and a pumping unit such as a pump which pressure-feeds the refrigerant to the refrigerant path 24 to circulate it in the refrigerant path 24. Thus, the refrigerant is supplied from the refrigerant supplier 25, and the one having come out of the refrigerant path 24 returns to the refrigerant supplier 25 again. It should be noted that any refrigerant may be used provided that it can cool the temperature of the processing space PS below the freezing point of the processing liquid via the inner wall surface 211.

The top of the processing tank 21 serves as a substrate entrance and can be opened and closed by driving a shutter 26 by a shutter driving mechanism 27. The substrates W can be loaded and unloaded through an opening by the lifter driving mechanism 22a with the top of the processing tank 21 opened, whereas the processing space PS in the processing tank 21 can become a sealed space with the top of the processing tank 21 closed. Further, the outer wall of the processing tank 21 and the shutter 26 are covered by a heat insulating material 28 in order to improve the cooling efficiency of the processing space PS in the sealed state.

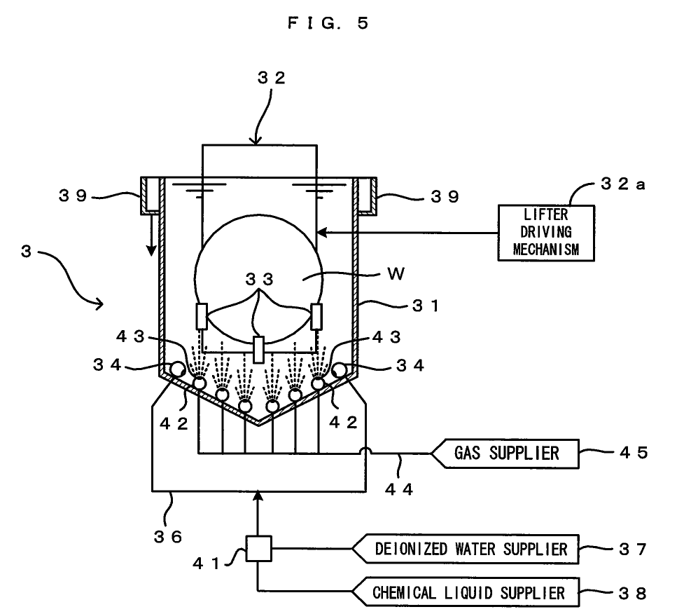

Next, the post-processing unit 3 is described with reference to FIG. 5. FIG. 5 is a diagram showing a construction of the post-processing unit 3 equipped in the substrate processing apparatus shown in FIG. 1. This post-processing unit 3 performs a process (post-processing) for removing the frozen films from the substrate surfaces by supplying post-processing liquid to the frozen films. The post-processing unit 3 includes a processing tank (corresponding to a “second processing chamber” of the present invention) 31 which stores cleaning liquid (deionized water or chemical liquid) as “post-processing liquid” of the present invention. In this post-processing unit 3, a deionized water supplier 37 and a chemical liquid supplier 38 are respectively connected to a mixing unit 41. Further, the mixing unit 41 is communicated with two processing liquid supply nozzles 34 disposed near the inner bottom of the processing tank 31 via a processing liquid supply pipe 36. Deionized water or chemical liquid can be selectively supplied from the mixing unit 41 to the processing tank 31 by actuating the deionized water supplier 37 and the chemical liquid supplier 38 in accordance with a control command from the control unit 8. Specifically, when both the deionized water supplier 37 and the chemical liquid supplier 38 are actuated, the chemical liquid and the deionized water are supplied to the mixing unit 41 to prepare cleaning liquid of specified concentration as the post-processing liquid. Then, the post-processing liquid is introduced from the mixing unit 41 to the processing tank 31 via the processing liquid supply nozzles 34. Thus, according to this embodiment, the processing liquid supply nozzles 34 function as a “post-processing liquid introducing section” of the present invention.

Besides deionized water, alkaline aqueous solution diluted to have a very low ammonia concentration (1% or below) is, for example, used as such cleaning liquid in order to suppress an etching amount (film thickness to be etched) of substrates to or below 1 angstrom, preferably to or below 0.4 angstrom. Further, surface-active agent may be added to the cleaning liquid in order to promote the removal of contaminants from substrate surfaces. It should be noted that a chemical liquid supplier having the same or similar construction may be provided for each chemical liquid in the case where a plurality of kinds of chemical liquids are used.

Similar to the preprocessing unit 1, a lifter 32 is so disposed in the post-processing unit 3 as to be movable upward and downward between an inner position (position shown in FIG. 5) in the processing tank 31 and an upper position above the processing tank 31, and is driven to elevate by a lifter driving mechanism 32a. Thus, a plurality of substrates W can be collectively immersed into the cleaning liquid stored in the processing tank 31. The cleaning liquid discharged from the respective processing liquid supply nozzles 34 overflows through an opening at the top of the tank while forming an upward flow, and is collected into an overflow tank 39. By causing the cleaning liquid to overflow in this manner, contaminants such as particles separated from the substrate surfaces can be discharged to the outside of the tank together with the cleaning liquid. Thus, the lifter driving mechanism 32a functions as an “immersing section” of the present invention according to this embodiment.

On the other hand, since the post-processing unit 3 is required to remove the contaminants adhering to the substrate surfaces from the substrate surfaces, contaminant removal performance is insufficient if the substrates W after the freezing process are only immersed in the cleaning liquid. Accordingly, the following construction is additionally provided in order to improve such contaminant removal performance. In other words, construction capable of supplying bubbles toward the respective surfaces of a plurality of substrates W immersed in the cleaning liquid is additionally provided.

A plurality of gas supply nozzles 42 are arranged at the inner bottom of the processing tank 31 and below the substrates W immersed in the cleaning liquid. The gas supply nozzles 42 are formed to extend in a horizontal direction in the arranged direction of the substrates W (direction normal to the substrate surfaces). A plurality of discharge holes 43 which discharge inert gas such as nitrogen gas are formed in each gas supply nozzle 42. These gas supply nozzles 42 are communicated with a gas supplier 45 via a gas supply pipe 44, so that nitrogen gas is supplied to the cleaning liquid stored in the processing tank 31 when nitrogen gas is pumped from the gas supplier 45 in accordance with an operation command from the control unit 8. Thus, bubbling by nitrogen gas is performed to form bubbles in the cleaning liquid. Then, the bubbles are supplied to the surfaces of the substrates W immersed in the cleaning liquid by buoyancy acting on the bubbles. As a result, the contaminants adhering to the substrate surfaces can be efficiently removed from the substrate surfaces as described later. Thus, the gas supply nozzles 42, the gas supply pipe 44 and the gas supplier 45 function as a “bubble generator” of the present invention according to this embodiment.

C. Operation of the Substrate Processing Apparatus

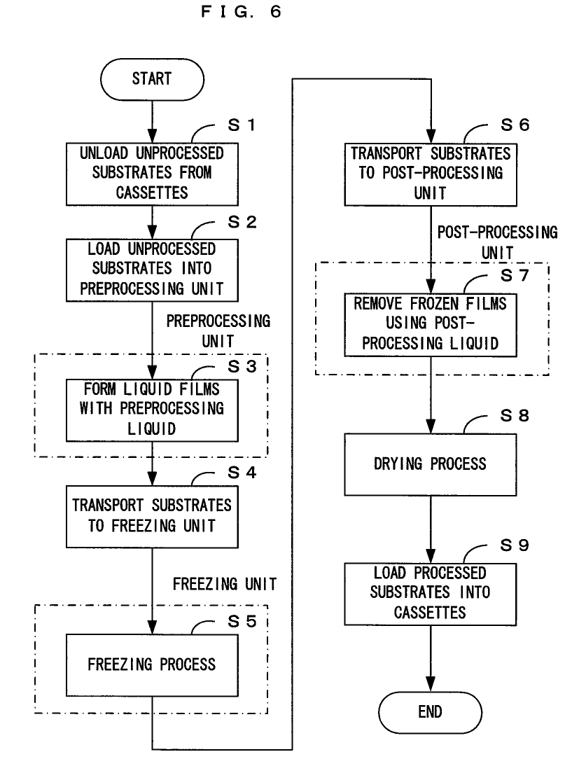

Next, the operation of the substrate processing apparatus constructed as above is described in detail with reference to FIG. 6. FIG. 6 is a flow chart showing the operation of the substrate processing apparatus shown in FIG. 1. Substrates W are carried to the substrate processing apparatus by means of the cassettes C, and the cassettes C each accommodating a plurality of unprocessed substrates W in upright posture in parallel with each other are placed in the cassette placing area 101 by a transporting vehicle (not shown) or the like. When the cassettes C are placed in the cassette placing area 101, two of these cassettes C are transported to the cassette placing table 401 by the cassette transferring robot 102. Then, the cassette placing table 401 is moved to a position below the substrate transporting robot 300 and the cassettes C are turned such that the arranged direction of the substrates W changes from X-direction to Y-direction. Then, the substrates W are thrust upward and all the unprocessed substrates W in the two cassettes C are taken out and are transferred to the substrate transporting robot 300 (Step S1).

The substrate transporting robot 300 having received the unprocessed substrates W moves to a position before the preprocessing unit 1 and loads the substrates W into the preprocessing unit 1 (Step S2). Specifically, the lifter 12 provided in the preprocessing unit 1 is kept on standby at the upper position (substrate transfer position) above the processing tank 11, and the substrate transporting robot 300 transfers the substrates W to the lifter 12. Subsequently, the lifter 12 is moved downward by actuating the lifter driving mechanism 12a to immerse the substrates W in the deionized water stored in the processing tank 11. Thereafter, the lifter 12 is moved upward to pull the substrates W from the deionized water stored in the processing tank 11. In this way, the deionized water adheres to the respective surfaces of the substrates W, whereby liquid films (water films) are collectively formed on the surfaces of the substrates W (Step S3: liquid film forming step).

Upon completing the liquid film forming process in this way, the substrates W are transferred from the lifter 12 to the substrate transporting robot 300. The substrate transporting robot 300 having received the substrates W transports the substrates W from the preprocessing unit 1 to the freezing unit 2 in the apparatus before the liquid films formed on the substrate surfaces dry (Step S4: first transporting step). In the freezing unit 2, the lifter 22 kept on standby at the upper position above the processing tank 21 receives the substrates W from the substrate transporting robot 300. Then, the lifter 22 is moved downward by actuating the lifter driving mechanism 22a to accommodate the substrates W in the processing space PS in the processing tank 21. It should be noted that the shutter 26 is opened to open the top of the processing tank 21 at this time.

The control unit 8 controls a transportation time such that the transportation of the substrates W from the preprocessing unit 1 to the freezing unit 2 is completed within a specified time limit. By transporting the substrates W in this way, the drying of the liquid films can be suppressed and the thickness of the liquid films remaining on the substrate surfaces can be precisely controlled. Specifically, contaminants having the size of 0.06 μm or larger are controlled in the present circumstances, but the size of contaminants to be actually removed covers a wide range including a subrange of 0.06 μm or smaller and a subrange of several μm or larger. Thus, it is preferable to control the thickness of the liquid films to a value equal to or larger than the size of contaminants to be removed. In this case, it is preferable to cause liquid films having the thickness of at least several tens of μm, preferably several hundreds of μm or larger to remain in order to effectively remove the contaminants from the substrates.

The shutter 26 is closed when the substrates W are accommodated into the processing tank 21. Here, since the temperature of the entire processing space PS in the processing tank 21 is cooled below the freezing point of the preprocessing liquid (deionized water), the liquid films adhering to the respective surfaces of the substrates W are simultaneously frozen (Step S5: freezing step). At this time, the contaminants adhering to the substrates W move only marginal distances due to the volume expansion of the liquid films (when water of 0° C. becomes ice of 0° C., the volume thereof increases by about 1.1 times). Specifically, the contaminants are moved away from the substrate surfaces by marginal distances since the liquid films having entered between the substrate surfaces and the contaminants increase in volume. As a result, adhesive forces between the substrates W and the contaminants are reduced and the contaminants even come to separate from the substrate surfaces. Thus, the contaminants adhering to the substrate surfaces can be easily removed by the post-processing in the post-processing unit 3 to be described later. Furthermore, although the processing liquid (deionized water) has entered spaces between the contaminants and the substrates W, the device patterns formed on the substrate surfaces integrally adhere to the substrates and, hence, the processing liquid does not enter spaces between these patterns and substrate bases. Therefore, only the contaminants can be selectively and preferentially removed from the substrate surfaces without peeling or destroying the patterns.

As described above, the freezing unit 2 exclusively performs the freezing process in this embodiment. Thus, in freezing a plurality of substrates W continuously, the temperature of the processing space PS can be stabilized and time required for the freezing process can be shortened by continuously keeping the temperature of the processing space PS at a temperature below the freezing point of the preprocessing liquid.

When the freezing of the liquid films is completed after the lapse of a specified period, the control unit 8 causes the shutter 26 to open and causes the lifter 22 to move upward to the upper position above the processing tank 21 and to transfer the substrates W after the freezing of the liquid films to the substrate transporting robot 300. When the substrates W are unloaded from the processing tank 21, the shutter 26 is closed until next substrates W are transported from the preprocessing unit 1 in order to stabilize the temperature of the processing space PS to the temperature described above.

Subsequently, the substrate transporting robot 300 transports the substrates W after the freezing of the liquid films from the freezing unit 2 to the post-processing unit 3 inside the apparatus (Step S6: second transporting step). Here, the substrates W may be transported at any arbitrary timing from the freezing unit 2 to the post-processing unit 3 unless being left unattended. In other words, the substrates W may be transported after the frozen films (ice films) melt or the transportation of the substrates W may be completed before the frozen films melt. However, by transporting the substrates W before the frozen films completely melt as in the latter case, the readhesion of the contaminants having separated from the substrates W once by the freezing process to the substrates W can be securely avoided. Accordingly, the control unit 8 preferably controls the transportation time such that the substrate transporting robot 300 completes the transportation of the substrates W before the frozen films melt.

When the substrates W after the freezing process are transported to the post-processing unit 3 by the substrate transporting robot 300, in the post-processing unit 3, the lifter 32 kept on standby at the upper position above the processing tank 31 receives the substrates W from the substrate transporting robot 300 and is moved downward by actuating the lifter driving mechanism 32a. In this way, the substrates W after the freezing process are collectively immersed into the cleaning liquid stored in the processing tank 31, whereby the cleaning liquid is simultaneously supplied to the respective surfaces of the substrates W. As a result, the frozen films on the substrate surfaces are defrosted by the cleaning liquid, and the frozen films containing the contaminants are removed from the substrate surfaces by the cleaning liquid convecting in the processing tank 31 and the bubbles in the cleaning liquid (Step S7: film removal step). Specifically, the bubbles are generated in the cleaning liquid stored in the processing tank 31 through the bubbling by nitrogen gas from the gas supply nozzles 42 and are supplied toward the substrate surfaces. Such bubbles can (1) trap the contaminants adhering to the substrate surfaces since contaminants have the property of gathering at interfaces between gas and liquid (cleaning liquid) and (2) remove the trapped contaminants from the substrate surfaces with the buoyancy acting on the bubbles. As a result, the contaminants can be effectively removed from the substrate surfaces by the function of reducing the adhesive forces of the contaminants to the substrate surfaces by the freezing process and the function of removing the contaminants by the bubbles. It should be noted that the contaminants removed from the substrate surfaces are discharged to the outside of the tank together with the cleaning liquid overflowing from the processing tank 31.

Further, since the substrates W are entirely immersed in the cleaning liquid, the undersides of the substrates are also cleaned by the functions of the cleaning liquid and the bubbles. Thus, the contaminants are removed not only from the substrate surfaces, but also from the entire substrates W.

When a series of cleaning processes (liquid film forming step+freezing step+film removal step) are completed in this way, the lifter 32 is moved upward to transfer the substrates W to the substrate transporting robot 300 at the upper position above the processing tank 31. Then, the substrate transporting robot 300 transports the substrates W to the drying unit 4. The drying unit 4 includes a drying chamber 41 and a lifter (not shown) which moves upward and downward between an inner space of the drying chamber 41 and an upper position above the drying chamber 41 (FIG. 1). The lifter receives the substrates W from the substrate transporting robot 300, allows the substrates W to be dried in the drying chamber 41, and transfers the dried substrates W to the substrate transporting robot 300 again (Step S8). It should be noted that the drying unit 4 may be constructed to dry the substrates W by heating and/or depressurizing the interior of the drying chamber 41 or may be constructed to steam dry the substrates W.

The substrate transporting robot 300 having received the dried substrates (processed substrates) W transports the substrates W to a position above the substrate transferring section 400 to transfer the substrates W to the cassette placing table 401. The processed substrates W are loaded into the two cassettes C on the cassette placing table 401 (Step S9). Thereafter, the cassettes C are transferred to the cassette placing area 101 by the cassette transferring robot 102. It should be noted that the empty cassettes C on the cassette placing table 401 are conveyed by the cassette transferring robot 102, cleaned by the cassette cleaning mechanism 103 and placed again on the cassette placing table 401. Accordingly, the processed substrates W are accommodated into the cleaned cassettes C.

As described above, according to this embodiment, the preprocessing unit 1, the freezing unit 2 and the post-processing unit 3 are separately arranged in the apparatus and the cleaning processes (liquid film forming step+freezing step+film removal step) are performed by transporting the substrates W from the preprocessing unit 1 to the freezing unit 2 and further from the freezing unit 2 to the post-processing unit 3 inside the apparatus by means of the substrate transporting robot 300. Thus, the freezing unit 2 exclusively performs the freezing process, and hence, there is no likelihood of accumulating cold in the preprocessing unit 1 and the post-processing unit 3. Accordingly, it is not necessary to apply heat more than necessary in removing the frozen liquid films from the substrates W in the post-processing unit 3. Therefore, energy efficiency can be improved and a processing time required for post-processing (film removal process) can be shortened.

Further, according to this embodiment, the freezing unit 2 freezes the liquid films (water films) by decreasing the temperature of the processing space PS to the temperature below the freezing point of the post-processing liquid (deionized water). Accordingly, it is sufficient for the freezing unit 2 to exclusively perform the freezing process even in the case where the volume of the processing space PS (volume of the processing tank 21) is increased to accommodate a plurality of substrates W, and hence, it is not necessary to increase or decrease the temperature of (apply heat or cold to) the processing space PS. Therefore, the efficiency of the cleaning processes can be improved while heat energy efficiency is improved and the processing time required for the freezing process is shortened. Further, process efficiency is synergistically improved since a plurality of substrates W are collectively processed in the respective processing units.

Further, according to this embodiment, even upon repeatedly performing a series of cleaning processes including the preprocessing process (liquid film forming process), the freezing process and the post-processing process (film removal process) in the production process, the respective processing units may perform their own processes at suitable temperatures. Thus, there is no likelihood of causing a thermal cycle in the processing space as opposed to the conventional technique in which the cleaning processes are performed in the same processing chamber. Accordingly, the processing time of each process can be remarkably shortened and energy efficiency can be improved as compared to the conventional technique. Further, set temperatures can be stabilized in the respective processing units since the respective processing units may perform their own processes at specified temperatures set therefor.

Further, according to this embodiment, since the substrates W are transported between the preprocessing unit 1 and the freezing unit 2 and between the freezing unit 2 and the post-processing unit 3 inside the apparatus, times required for the transportation can be easily controlled, and hence, various parameters in the cleaning processes can be precisely controlled. That is to say, according to this embodiment, the control unit 8 which controls the entire apparatus can control the transportation times by the substrate transporting robot 300 and the cleaning parameters (processing times by the processing liquids, freezing time, etc.) in the respective processing units while the processing units in charge of the corresponding ones of a series of cleaning processes (liquid film forming step+freezing step+film removal step) are separated inside the apparatus. Therefore, a series of cleaning processes can be efficiently performed, the processing times can be shortened and the substrates W can be satisfactorily cleaned.

Particularly, concerning the transportation of the substrates W, the substrates W are transported from the preprocessing unit 1 to the freezing unit 2 before the liquid films formed on the substrate surfaces dry, whereby the variation of the thicknesses of the liquid films caused by the drying of the liquid films can be suppressed and amounts of liquid (thickness of the liquid films) remaining on the substrates to be subjected to the freezing process can be precisely controlled. Further, by transporting the substrates W from the freezing unit 2 to the post-processing unit 3 before the frozen films melt, the readhesion of contaminants having separated from the substrates W by the freezing process to the substrates W can be securely avoided and the removal rate of the contaminants can be improved.

Further, according to this embodiment, the cleaning liquid stored in the processing tank 31 is caused to overflow and bubbles are supplied to the surfaces of a plurality of substrates W immersed in the cleaning liquid in the post-processing unit 3. Thus, the contaminants having weakened adhesive forces to the substrate surfaces in the frozen films and those having separated from the substrate surfaces can be effectively removed from the substrate surfaces by the contaminant removing action by the bubbles. In other words, the contaminants adhering to the substrate surfaces can be trapped by the bubbles and the trapped contaminants can be efficiently removed from the substrate surfaces by buoyancy acting on the bubbles.

### Modification to First Embodiment

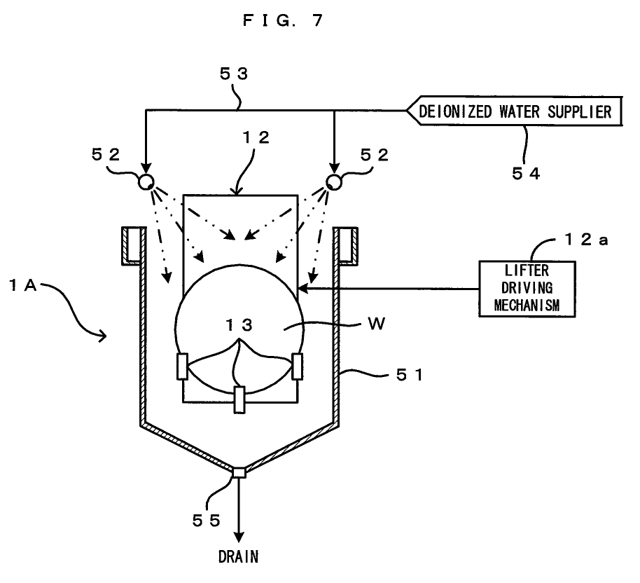

It should be appreciated that the present invention is not limited to the above first embodiment and various other modifications can be made without departing from the spirit of the present invention. For example, in the above first embodiment, the preprocessing unit 1 forms the liquid films on the surfaces of a plurality of substrates W by immersing the respective substrates W into the preprocessing liquid stored in the processing tank 11 and then pulling the substrates W up. However, the liquid film forming method is not limited to this. The preprocessing liquid may be showered to the substrate surfaces, for example, as shown in FIG. 7 to form liquid films on the substrate surfaces.

FIG. 7 is a diagram showing a modification of the preprocessing unit. This preprocessing unit 1A includes shower nozzles 52 near the top of a processing tank 51. Two shower nozzles 52 are disposed at the opposite sides of the substrates W accommodated in a processing tank 51, and are formed to extend in a horizontal direction in the arranged direction of a plurality of substrates W (direction normal to substrate surfaces). These shower nozzles 52 are respectively communicated with a deionized water supplier 54 via a deionized water supply pipe 53, so that deionized water is showered toward the substrate surfaces from the respective shower nozzles 52 upon being pressure fed from the deionized water supplier 54 in accordance with an operation command from the control unit 8. Thus, deionized water is simultaneously supplied to the surfaces of the respective substrates W, and liquid films are collectively formed on the surfaces of the respective substrates W. It should be noted that deionized water introduced to the bottom of the processing tank 51 without adhering to the substrate surfaces is drained through a liquid discharge port 55 formed at the bottom of the processing tank 51. According to this modification, the shower nozzles 52 function as a “first shower nozzle” of the present invention.

As described above, liquid films may be formed on the substrate surfaces by immersing the substrates W into the preprocessing liquid and pulling them up from the preprocessing liquid or may be formed on the substrate surfaces by showering the preprocessing liquid toward the substrates W. Regardless of which construction is adopted, the preprocessing unit can be simply constructed and the preprocessing process (liquid film forming process) can be collectively performed to a plurality of substrates W. Therefore, the process efficiency of the preprocessing can be improved.

Further, the construction shown in FIG. 7 may also be adopted for the post-processing unit 3 to remove frozen films from the substrate surfaces by showering the post-processing liquid to the substrate surfaces. By showering the post-processing liquid from the shower nozzles 52 to simultaneously supply the post-processing liquid to a plurality of substrates W accommodated in the processing tank 51 after the freezing process, the frozen films can be removed from the respective surfaces of the substrates W. According to such a construction, contaminants having adhesive forces to the substrate surfaces weakened by the freezing process can be sufficiently removed by the striking power of the showered post-processing liquid. Accordingly, in this case, it is preferable to regulate a discharge pressure from the shower nozzles 52 with the object of removing the contaminants. In this modification, the shower nozzles 52 function as a “second shower nozzle” of the present invention.

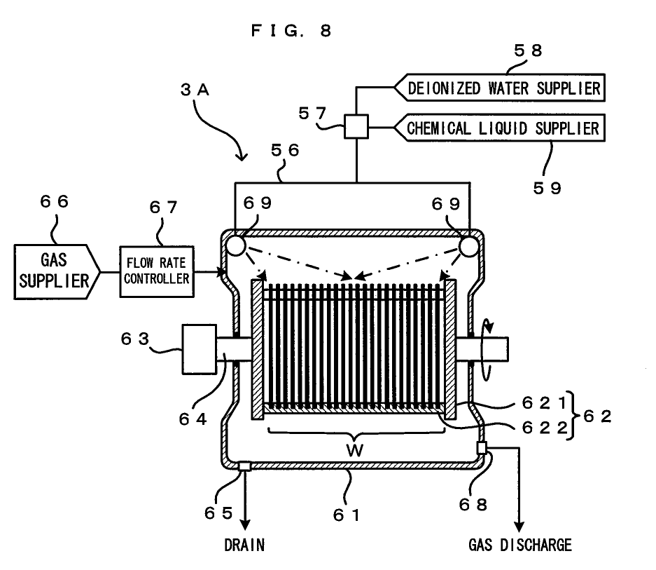

Furthermore, the post-processing unit may be so constructed as to shower the post-processing liquid to the substrate surfaces while rotating the substrates W as shown in FIG. 8. FIG. 8 is a diagram showing a modification of the post-processing unit. This post-processing unit 3A includes a processing chamber 61 and can shower post-processing liquid to the surfaces of a plurality of substrates W while rotating all the substrates W together in the processing chamber 61. The processing chamber 61 accommodates a plurality of substrates W loaded into the processing chamber 61 by the substrate transporting robot 300 while holding them in upright posture. Specifically, a plurality of substrates W are held by a carrier 62 while being spaced apart from one another and aligned in a horizontal direction. The carrier 62 functions as a “substrate holder” of the present invention and includes disc-shaped carrier main bodies 621 and, for example, three substrate holding columns 622 which extend in a horizontal direction, which is held upright relative to the carrier main bodies 621, and which hold a plurality of substrates W. In the three substrate holding columns 622, a plurality of notch-shaped holding grooves which engage with parts of peripheral edge portions of the substrates W are formed in an arrangement with specified intervals in-between in the longitudinal direction (horizontal direction) of the substrate holding columns 622.

A spin motor 63 (corresponding to a “rotator” of the present invention) is coupled to the carrier 62, which is rotatable about a horizontally extending axis by the driving of the spin motor 62. Specifically, one end of a rotary shaft 64 is coupled to a rotary shaft of the spin motor 63, and the other end of the rotary shaft 64 is connected to the carrier main bodies 621, and the substrates W held by the substrate holding columns 622 are rotated about the horizontally extending axis by the driving of the spin motor 63. Thus, liquid components adhering to the substrates W are sputtered from the substrates by a centrifugal force resulting from the rotation of the substrates W. It should be noted that a liquid discharge port 65 is formed at the bottom of the processing chamber 61 and the liquid components sputtered from the substrates can be drained out from the chamber through the liquid discharge port 65.

Further, a nitrogen gas supplier 66 is communicated with the inner space of the processing chamber 61 via a flow rate controller 67 in order to control atmosphere in the processing chamber 61. On the other hand, the atmosphere in the processing chamber 61 can be discharged out through a gas discharge port 68. Thus, the formation of undesired oxide films and the like on the substrate surfaces and the adhesion of a mist of cleaning liquid on the substrate surfaces during the execution of the post-processing process (film removal process) can be prevented.

Further, two shower nozzles (corresponding to a “second shower nozzle” of the present invention) 69 are mounted on the ceiling surface of the processing chamber 61 at the left and right sides of the substrates W. These shower nozzles 69 are connected to a mixing unit 57 via a processing liquid supply pipe 56. Further, a deionized water supplier 58 and a chemical liquid supplier 59 are respectively connected to the mixing unit 57. Deionized water or chemical liquid can be selectively pressure fed via the mixing unit 57 to the shower nozzles 69 by actuating the deionized water supplier 58 and the chemical liquid supplier 59 in accordance with a control command from the control unit 8. Specifically, when both the deionized water supplier 58 and the chemical liquid supplier 59 are actuated, the chemical liquid and the deionized water are supplied to the mixing unit 57 to prepare cleaning liquid of specified concentration as the post-processing liquid. Then, the cleaning liquid is showered to a plurality of substrates W from the shower nozzles 69.

According to this construction, contaminants can be efficiently discharged from the substrate surfaces together with the cleaning liquid by the action of the striking power of the showered cleaning liquid and the centrifugal force resulting from the rotation of the substrates W, whereby the contaminants can be securely removed from the substrates W. That is to say, the contaminants having adhesive forces to the substrates W weakened by the freezing process are washed away by the showered cleaning liquid and the flow velocity thereof is increased by the centrifugal force to promote the removal of the contaminants from the substrates W.

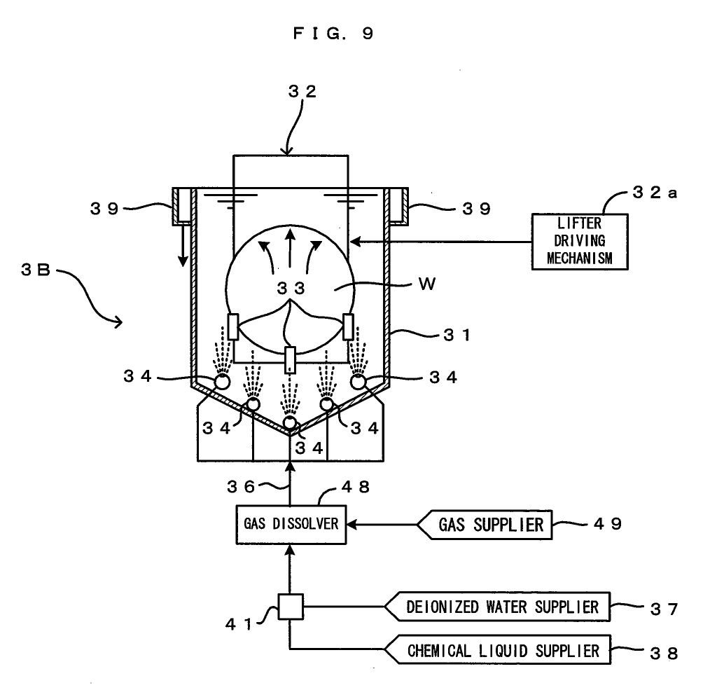

Further, although the post-processing unit 3 is constructed such that nitrogen gas is supplied to the cleaning liquid stored in the processing tank 31 and bubbles are generated in the cleaning liquid by causing the nitrogen gas to bubble in the cleaning liquid in the above first embodiment, the bubble generator is not limited to this construction. For example, a gas dissolver 48 may be disposed in the processing liquid supply pipe 36 between processing liquid supply nozzles 34 and a mixing unit 41 as in a post-processing unit 3B shown in FIG. 9. A gas supplier 49 is connected to this gas dissolver 48, so that inert gas such as nitrogen gas can be fed to the gas dissolver 48 by actuating the gas supplier 49 in accordance with an operation command from the control unit 8 and the nitrogen gas can be supersaturatedly dissolved into the cleaning liquid pumped from the mixing unit 41 to the processing liquid supply nozzles 34. A gas dissolving membrane formed by hollow fibers can be, for example, used as such a gas dissolver 48. The other construction is similar to the post-processing unit 3 described in the above first embodiment. By such a construction, bubbles can be formed in the cleaning liquid stored in the processing tank 31 by introducing the cleaning liquid, in which nitrogen gas is supersaturatedly dissolved, into the processing tank 31, and the same functions and effects as the above first embodiment can be obtained. Thus, in this modification, the gas dissolver 48 and the gas supplier 49 function as a “bubble generator” of the present invention.

Further, in the above first embodiment, the liquid films adhering to the respective surfaces-to-be-processed of a plurality of substrates W are frozen by accommodating the substrates W in the processing tank 21 while holding them by the substrate holding guides 23 in the freezing unit 2.

The following technologies are also known as those of freezing liquid present on a surface-to-be-processed of a substrate while cooling the substrate as described above. For example, in an apparatus disclosed in Japanese Patent No. 3343013, a substrate is cleaned as described below utilizing such a freezing technology as a part of a substrate cleaning method. This apparatus includes a cooling and ice-making section which cools a substrate below zero to form ice on a surface (surface-to-be-processed) thereof and an ice removing section which removes the ice formed on the substrate surface. The substrate having the ice formed on the surface thereof is transported from the cooling and ice-making section to the ice removing section, and the ice is removed from the substrate surface in the ice removing section. Specifically, the cooling and ice-making section includes a cooling plate, on which the substrate is placed to be cooled below zero. Gas containing a mist of water is supplied to the substrate surface with the substrate cooled in this way. As a result, the mist of water freezes on the substrate surface to form ice chips on the substrate surface. Subsequently, the substrate is taken out from the cooling and ice-making section and transferred to the ice removing section. In the ice removing section, gas is ejected at high pressure to the substrate surface to remove the ice chips from the substrate surface.

Another substrate processing method utilizing the freezing technology is as follows. Specifically, this is a method for suppressing the adhesion of particles floating in the outside atmosphere to surfaces-to-be-processed of substrates by freezing liquid adhering to the surfaces-to-be-processed. For example, in an apparatus disclosed in JP-A-11-111658, substrates are immersed in a processing tank accommodating processing liquid to be subjected to etching process and cleaning process (rinsing process). The substrates are transported to another specified position by a transporting robot to be dried after the cleaning process. Upon this transportation of the substrates, the generation and adhesion of particles during the transportation of the substrates can be prevented by freezing the processing liquid adhering to the substrates until the substrates reach a drying process for drying the substrates. Specifically, the substrates are held by a substrate guide (holder) provided in a lifter, and the substrates held by the substrate guide are moved upward toward the outside atmosphere from a state immersed in the processing liquid by driving the lifter. In the process of exposing the substrates from the processing liquid to the outside atmosphere, chilling gas is supplied to the substrates. Thus, the processing liquid adhering to the substrates freezes and the substrate surfaces (surfaces-to-be-processed) are covered by the frozen processing liquid. As a result, the adhesion of particles floating in the outside atmosphere to the substrate surfaces is prevented. Thereafter, the substrates subjected to the freezing process are transferred from the lifter to the transporting robot and transported to another specified position by the transporting robot.

Incidentally, in the apparatus disclosed in Japanese Patent No. 3343013, there are cases that the mist of water is supplied to the substrate cooled below zero. At this time, the mist of water is not only supplied to the surface of the substrate (one principal surface of the substrate), but also enters space between the underside of the substrate (other principal surface of the substrate) and the cooling plate. As a result, water comes to be present between the periphery of the underside of the substrate and the cooling plate. The following problem has sometimes occurred in the case where water is present between the periphery of the underside of the substrate and the cooling plate. Specifically, the water present between the periphery of the underside of the substrate and the cooling plate is cooled into ice, with the result that the periphery of the underside of the substrate and cooling plate strongly adhere to each other. Thus, the substrate cannot be taken out of the cooling and ice-making section upon transporting the substrate from the cooling and ice-making section to the ice removing section. Therefore, there has been a likelihood of causing an error in unloading the substrate.

In the apparatus disclosed in JP-A-11-11658 as well, there has been a likelihood of causing an error in unloading the substrate. Specifically, in this apparatus, the substrates held by the substrate guide are moved upward from the state immersed in the processing liquid and the chilling gas is supplied toward the substrates exposed to the outside atmosphere. At this time, in the case where the processing liquid has entered spaces between the substrate guide and the substrates, the processing liquid is frozen and the substrate guide and the substrates are strongly adhered to each other in some cases. As a result, upon transporting the substrates to another specified position by the transporting robot after the cleaning process, it has not been possible to transfer the substrates from the lifter to the transporting robot, thereby being likely to cause an error in unloading the substrates.

Thus, there has been a demand to securely unload the substrates without causing an unloading error after the liquid films formed on the surfaces-to-be-processed of the substrates are frozen. In order to meet such a demand, the substrate holding guides 23 equipped in the freezing unit 2 are preferably constructed as follows in the above first embodiment as well.

FIG. 10 is a partial enlarged view of the substrate holding guide equipped in the freezing unit. In each substrate holding guide 23, a plurality of notch-shaped holding grooves G3 are formed which engage with parts of peripheral edge portions of the substrates W in an arrangement with specified intervals in-between in the longitudinal direction thereof (direction normal to the surfaces of the substrates W) in order to hold the substrates W. Thus, a plurality of substrates W are held by the substrate holding guides 23 while being spaced apart at specified intervals in the longitudinal direction of the substrate holding guides 23 by inserting the substrates W into the respective holding grooves G3. Contact parts 23a of each substrate holding guide 23 where the holding grooves G3 are formed and which are to be kept in contact with the substrates W is made of fluororesin having a water-repellent property to the liquid (deionized water, hereinafter referred to as DIW) forming the liquid films.

As the fluororesin, tetrafluororesins such as PTFE (polytetrafluoroethylene), trifluororesins such as PCTFE (polychlorotrifluoroethylene) and PFA (tetrafluoroethylene perfluoroalkyl vinyl ether copolymer), or difluororesins such as PVDF (polyvinylidenefluoride) can be used. Particularly, it is preferable to use a tetrafluororesin as the fluororesin in light of a magnitude of a contact angle to water.

According to this construction, a plurality of substrates W are transported to the freezing unit 2 by the substrate transporting robot 300 in a state that the liquid films made of DIW adhere to the surfaces of the respective substrates W. In the freezing unit 2, the lifter 22 kept on standby at the upper position above the processing tank 21 receives the substrates W from the substrate transporting robot 300. Then, the lifter 22 is moved downward by actuating the lifter driving mechanism 22a to accommodate the substrates W in the processing space PS in the processing tank 21. When the substrates W are accommodated into the processing tank 21, the shutter 26 is closed. Since the temperature of the entire processing space PS in the processing tank 21 is cooled below the freezing point of the processing liquid (DIW), the liquid films adhering to the surfaces of the respective substrates W freeze.

Here, in the case where the liquid (DIW) forming the liquid films has entered spaces between the contact parts 23a and the substrates W, this liquid also freezes. And when the liquid having entered the spaces between the contact parts 23a and the substrates W freezes, the frozen liquid adheres to the substrates W with a relatively large adhesive force. On the other hand, since the contact parts 23a are made of the water-repellent material, the wetting angle (contact angle) of the liquid having entered the spaces between the contact parts 23a and the substrates W to the contact parts 23a becomes larger than that to the substrates W. Accordingly, the adhesive force of the frozen liquid to the contact parts 23a can be made smaller. Therefore, the strong adhesion of the substrate holding guides 23 and the substrates W via the frozen liquid can be prevented.

Thereafter, the control unit 8 opens the shutter 26 and moves the lifter 22 upward to the upper position above the processing tank 21. Then, a plurality of substrates W subjected to the freezing process are easily separated from the substrate holding guides 23 and transferred to the substrate transporting robot 300. Accordingly, the substrates W subjected to the freezing process are securely unloaded without causing any unloading error upon being unloaded from the freezing unit 2.

### Second Embodiment

Further, in the above first embodiment, although the transporting mechanism such as the substrate transporting robot collectively loads a plurality of substrates W into the post-processing unit after collectively unloading the substrates W subjected to the freezing process from the freezing unit, the present invention is not limited to this. For example, the transporting mechanism may load the substrates W subjected to the freezing process one by one into a wet processing unit that functions as the post-processing unit after unloading them one by one from the freezing unit. Second to fifth embodiments having such a construction are described below.

FIG. 11 is a plan layout diagram of a substrate processing apparatus of a second embodiment. FIG. 12 is a block diagram showing a main control construction of the substrate processing apparatus shown in FIG. 11. In this substrate processing apparatus, a wet processing unit 10 and a freezing unit 20 are arranged while being separated from each other by a specified distance, and a transporting mechanism (corresponding to a “transporting section” of the present invention) 30 is arranged between the units 10 and 20. Out of these units, the wet processing unit 10 is a unit which forms a liquid film on a surface (one principal surface) of each substrate such as a semiconductor wafer and removes the liquid film (frozen film) after the freezing. Specifically, the wet processing unit 10 forms the liquid film on the substrate surface by rotating the substrate to sputter the liquid supplied to the substrate. The substrate having the liquid film formed on the surface thereof is transferred to the freezing unit 20 by the transporting mechanism 30. In the freezing unit 20, a frozen film is formed by freezing the liquid film by applying a freezing process to the substrates. The substrate subjected to the freezing process is transported by the transporting mechanism 30 to the wet processing unit 10, in which the substrate is cleaned and the frozen film is removed from the substrate surface. Hereinafter, the constructions and operations of the wet processing unit 10 and the freezing unit 20 are described in detail with reference to the drawings. It should be noted that the construction and operation of the transporting mechanism 30 are not described here since a conventionally frequently used mechanism is employed as such.

FIG. 13 is a diagram showing a construction of the wet processing unit equipped in the substrate processing apparatus shown in FIG. 11. This wet processing unit 10 performs a liquid film forming process and a frozen film removal process to a surface, as a surface-to-be-processed, of the substrate W held by a spin chuck 71. Specifically, the wet processing unit 10 can form the liquid film of DIW by supplying DIW to the substrate surface and can remove the liquid film after the freezing (frozen film) by supplying the DIW to the substrates W subjected to the freezing process. Thus, the wet processing unit 10 functions as a “post-processing unit” of the present invention in this embodiment.

The spin chuck 71 includes a disc-shaped base member 711 that also functions as a blocking member at the underside of the substrate, and three or more chuck pins 712 arranged on the upper surface of the base member 711. Each of these chuck pins 712 includes a supporting portion 712a which supports the outer peripheral end of the substrate W from below and a restricting portion 712b which restricts the position of the outer peripheral edge of the substrate W. The chuck pins 712 are arranged near the outer peripheral end of the base member 711. The respective restricting portions 712b are constructed to take such an operative state as to hold the substrate W by being kept in contact with the outer peripheral edge of the substrate W and such an inoperative state as to free the substrate W by being moved away from the outer peripheral edge of the substrate W. In the inoperative state, the restricting portions 712b enable the substrate W to be loaded onto and unloaded from the supporting portions 712a by the transporting mechanism 30. On the other hand, by switching the respective restricting portions 712b to the operative state after the substrate W is placed on the supporting portions 712a with the surface (pattern forming surface) of the substrate W faced up, whereby the substrate W is held by the spin chuck 71.

Further, the upper end of a hollow rotary shaft 72 is mounted to the lower surface of the base member 711. A pulley 73a is firmly fixed to the bottom end of this rotary shaft 72, and a torque of a motor 73 is transmitted to the rotary shaft 72 via a belt 73c spanning between this pulley 73a and a pulley 73b firmly fixed to the rotary shaft of the motor 73. Thus, the substrate W held by the spin chuck 71 is rotated about the center thereof by driving the motor 73.

A nozzle 74 is fixedly disposed in the center of the base member 711. A processing liquid supply pipe 75 is inserted into the hollow rotary shaft 72, and the nozzle 74 is coupled to the upper end thereof. The processing liquid supply pipe 75 is connected to a DIW supplier which supplies DIW via a valve 76. The DIW can be discharged from the nozzle 74 by being supplied from the DIW supplier. Such a DIW supplier is equipped, for example, as a factory-side utility in a factory where the substrate processing apparatus is installed.

Further, a clearance between the inner wall surface of the rotary shaft 72 and the outer wall surface of the processing liquid supply pipe 75 forms a cylindrical gas supply passage 77. This gas supply passage 77 is connected to a gas supplier via a valve 78, so that nitrogen gas can be supplied to a space between the base member 711 as a blocking member and the underside (other principal surface) of the substrate W. Such a gas supplier is equipped, for example, as a factory-side utility in a factory where the substrate processing apparatus is installed. Although nitrogen gas is supplied from the gas supplier in this embodiment, air or another inert gas may be discharged.

A blocking member 81 is disposed above the spin chuck 71. This blocking member 81 is mounted to the bottom end of a vertically arranged suspension arm 82. A motor 83 is disposed at the upper end of this suspension arm 82, so that the blocking member 81 is rotated about the suspension arm 82 by driving the motor 83. It should be noted that the center of rotation of the rotary shaft 72 of the spin chuck 71 and that of the suspension arm 82 are aligned, so that the base member 711 as the blocking member, the substrate W held by the spin chuck 71 and the blocking member 81 are concentrically rotated. Further, the motor 83 is constructed to rotate the blocking member 81 in the same direction and substantially at the same rotating speed as (the substrate W held by) the spin chuck 71.

Further, the blocking member 81 is connected to a blocking-member elevating mechanism 89, so that the blocking member 81 can be moved toward the base member 711 to face the base member 711, and conversely, away therefrom by actuating the blocking-member elevating mechanism 89 in accordance with an operation command from a control unit 40. Specifically, the control unit 40 causes the blocking member 81 to move upward to a retracted position above the spin chuck 71 upon loading and unloading the substrate W into and from the substrate processing apparatus by actuating the blocking-member elevating mechanism 89. On the other hand, the control unit 40 causes the blocking member 81 to move downward to a specified facing position (position shown in FIG. 13) set very close to the surface of the substrate W held by the spin chuck 71 upon cleaning the substrate at a substrate processing position (height position of the substrate W held by the chuck pins 712) where the substrate W is distanced upward from the base member 711 by a specified distance.

A nozzle 84 is disposed in the center of the blocking member 81. A processing liquid supply pipe 85 is inserted into the hollow suspension arm 82, and the nozzle 84 is coupled to the bottom end thereof. The processing liquid supply pipe 85 is connected to a DIW supplier which supplies DIW via a valve 86. The DIW can be discharged from the nozzle 84 by being supplied from the DIW supplier.

A clearance between the inner wall surface of the suspension arm 82 and the outer wall surface of the processing liquid supply pipe 85 forms a cylindrical gas supply passage 87. This gas supply passage 87 is connected to a gas supplier via a valve 88, so that nitrogen gas can be supplied to a space formed between the blocking member 81 and the surface (one principal surface) of the substrate W.

Further, a cup 79 which prevents the processing liquid from splashing to the surrounding area is arranged around the spin chuck 71. The processing liquid collected by the cup 79 is discharged to the outside of the apparatus to be stored in a tank (not shown) disposed below the cup 79.

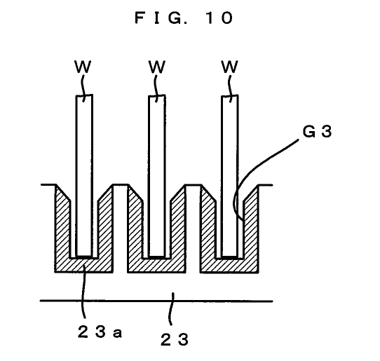

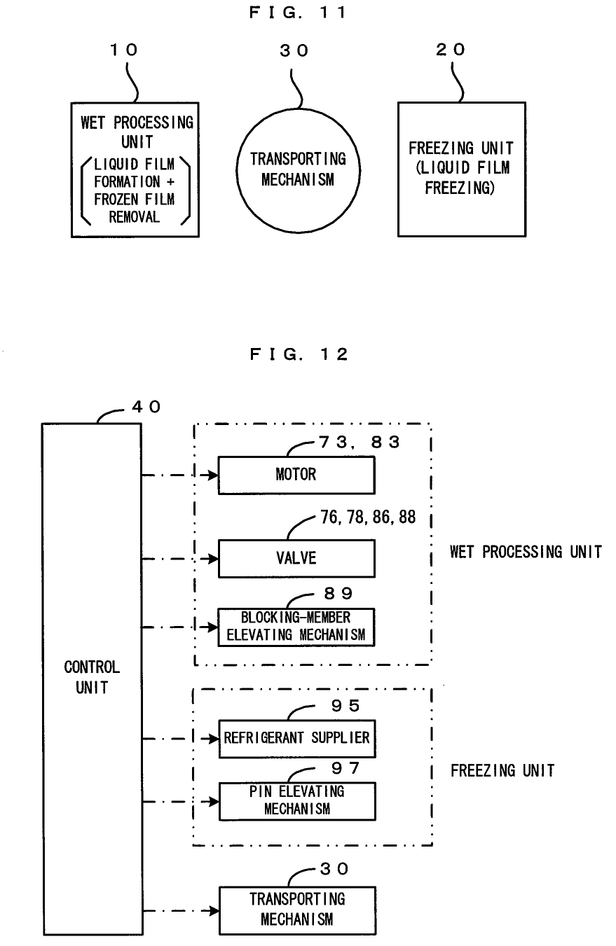

Next, the freezing unit 20 equipped in the substrate processing apparatus shown in FIG. 11 is described with reference to FIG. 14. FIG. 14 is a diagram showing a construction of the freezing unit, and FIG. 15 is a plan view of a cooling plate disposed in the freezing unit shown in FIG. 14. This freezing unit 20 performs a freezing process for freezing the liquid film formed on the substrate surface. The freezing unit 20 includes a cooling plate (facing member) 92 having a size equal to or slightly larger than the substrate in plan view in a processing chamber (cooling chamber) 91 substantially in the form of a rectangular parallelepiped defined by a partition wall 90. This cooling plate 92 includes a disc-shaped member 921 and an annular member 922 arranged to surround the periphery of the disc-shaped member 921. In other words, the cooling plate 92 is constructed by fitting the disc-shaped member 921 into a hollow portion of the annular member 922.

Here, the disc-shaped member 921 is made of metal such as aluminum in view of thermal conductivity of cold or made of quartz in view of cleanness, whereas the annular member 922 is made of fluororesin having a water-repellent property to liquid (DIW) forming the liquid film. As the fluororesin, tetrafluororesins such as PTFE (polytetrafluoroethylene), trifluororesins such as PCTFE (polychlorotrifluoroethylene) and PFA (tetrafluoroethylene perfluoroalkylvinylether copolymer), or difluororesins such as PVDF (polyvinylidenefluoride) can be used. Particularly, it is preferable to use a tetrafluororesin as the fluororesin in light of a magnitude of a contact angle to water.

In the cooling plate 92, a substrate facing surface 92a is formed which includes a circular central part 921a and an annular peripheral part 922a as shown in FIG. 15. Specifically, the substrate facing surface 92a is formed by uniting a substrate facing surface of the disc-shaped member 921 and that of the annular member 922. The substrate facing surface 92a is arranged to be substantially horizontal, and can face the underside of the substrate W opposite to the surface (frozen film forming surface) thereof, i.e. surface on which no frozen film is formed, out of the two principal surfaces of the substrate W. In this embodiment, ring width RW of the peripheral part 922a, i.e. a distance from the peripheral end surface of the disc-shaped member 921 to the outer edge of the annular member 922 in a radial direction is set at about 10 mm. Such ring width RW is set, for example, in view of run-around width of the liquid (DIW) forming the liquid film around the peripheral edge portion of the underside of the substrate at the time of forming the liquid film (distance the liquid runs from the circumferential end surface of the substrate W toward the center of the substrate W).

A plurality of spherical proximity balls (supporters) 93 project from the substrate facing surface 92a. A refrigerant path 94 is formed substantially in parallel with the substrate facing surface 92a inside the disc-shaped member 921, and the opposite ends thereof are connected to a refrigerant supplier 95. The refrigerant supplier 95 includes a cooling mechanism which cools refrigerant and a pumping mechanism such as a pump which pressure-feeds the refrigerant to the refrigerant path 94 to circulate it in the refrigerant path 94. Thus, the refrigerant is supplied from the refrigerant supplier 95 and the one having come out of the refrigerant path 94 is returned to the refrigerant supplier 95 again. Any refrigerant may be used provided that it can cool the substrate facing surface 92a below the freezing point of liquid forming the liquid film. In this embodiment, since the liquid film is made of DIW, the surface temperature of the substrate facing surface 92a is set at a temperature below the freezing point (ice point) of DIW.

A plurality of lift pins 96 are arranged to vertically penetrate the cooling plate 92, and an approaching/receding mechanism which brings the substrates W toward and away from the substrate facing surface 92a are constructed by the lift pins 96 and a pin elevating mechanism 97 including an air cylinder which moves the lift pins 96 upward and downward. The lift pins 96 can support the substrate W on the upper ends thereof. The lift pins 96 can support the substrate W at a substrate transferring height (position shown in chain double-dashed line) where the substrate W is transferred to and from the transporting mechanism 30 by being moved upward by the pin elevating mechanism 97 and, in addition, can place the substrate W on the substrate facing surface 92a (on the proximity balls 93 to be precise, position shown in solid line) by being retracted until the upper ends thereof are located below the substrate facing surface 92a of the cooling plate 92 (below the proximity balls 93 to be precise).

In a front partition wall 90a the transporting mechanism 30 can face a substrate transit port 99 is formed at a position corresponding to the substrate transferring height. A transportation arm (not shown) of the transporting mechanism 30 enters the processing chamber 91 through this substrate transit port 99 to transfer the substrate W with the lift pins 96. The respective operations of the refrigerant supplier 95 and the pin elevating mechanism 97 described above are controlled by the control unit 40 (FIG. 12).

Next, an operation of the substrate processing apparatus constructed as above is described in detail with reference to FIG. 16. FIG. 16 is a flow chart showing the operation of the substrate processing apparatus shown in FIG. 11. In this apparatus, the control unit 40 controls the respective parts of the apparatus and performs a series of cleaning processes (liquid film formation+liquid film freezing+frozen film removal) to the substrate surface. The substrate W subjected to a specified processing in the previous process is transported to the wet processing unit 10 and held by the spin chuck 71. Here, a fine pattern may be formed on the surface of the substrate W in some cases. In other words, the substrate surface serves as a pattern forming surface. Accordingly, in this embodiment, the substrate W is held by the spin chuck 71 with the substrate surface (pattern forming surface) faced up. It should be noted that the blocking member 81 is located at a distanced position in order to avoid interference with the substrate W.

When the substrate W is held by the spin chuck 71, the blocking member 81 is moved down to the facing position to be arranged in proximity to the substrate surface. Then, the control unit 40 causes the motor 73 to be driven to rotate the spin chuck 71, and causes the DIW to be supplied to the substrate surface from the nozzle 84. Thus, the DIW supplied to the substrate surface is evenly spread radially outward of the substrates W by the action of a centrifugal force resulting from the rotation of the substrate W, and part thereof is sputtered from the substrate W. As a result, the thickness of the liquid film is uniformly controlled over the entire substrate surface and a liquid film (water film) having a specified thickness (e.g. 100 μm) is formed on the entire substrate surface (Step S11). Meanwhile, in forming the liquid film, it is not essential to sputter part of the DIW supplied to the substrate surface as described above. For example, the liquid film may be formed on the substrate surface without sputtering the DIW from the substrate W with the rotation of the substrate W stopped or with the substrate W rotated at a relatively low speed.

When the formation of the liquid film is completed in this way, the motor 73 is stopped and the blocking member 81 is moved upward to the retracted position. Then, the substrate W is transported from the wet processing unit 10 to the freezing unit 20 by the transporting mechanism 30 (Step S12). Specifically, after being unloaded from the wet processing unit 10 by the transporting mechanism 30, the substrate W having the liquid film formed on the surface thereof is loaded into the processing chamber 91 of the freezing unit 20 and placed on the lift pins 96. It should be noted that the lift pins 96 are moved upward to the substrate transferring height before the substrate W is loaded into the processing chamber 91.

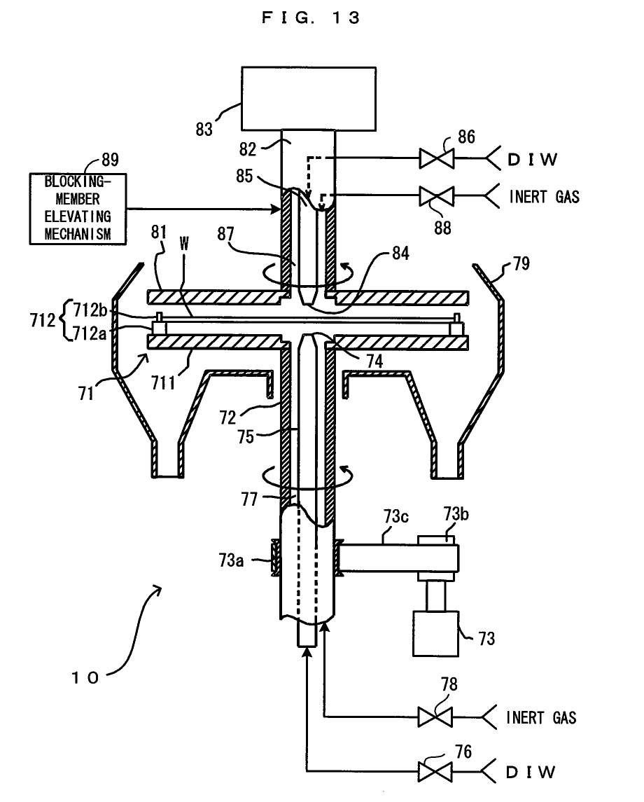

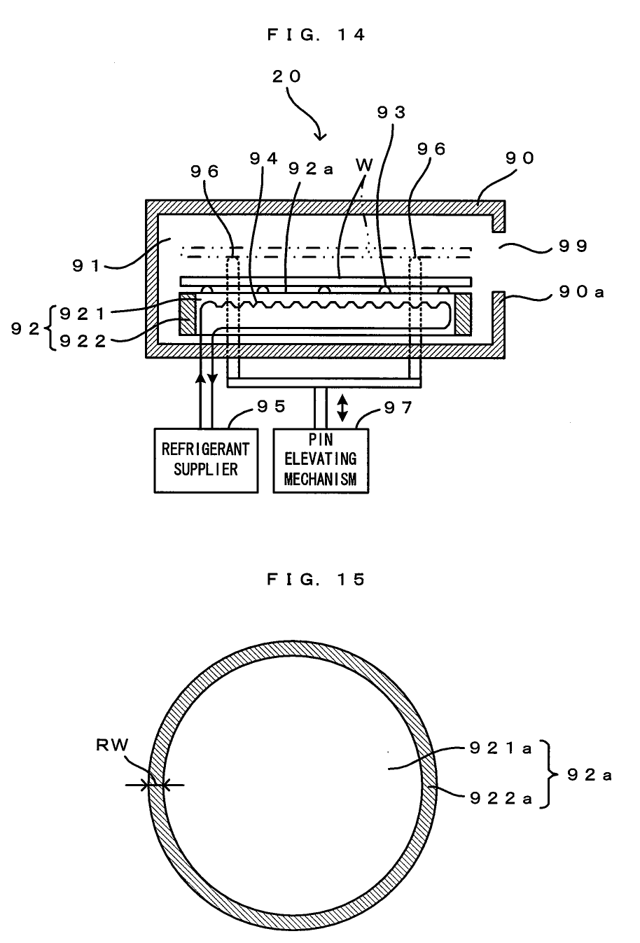

FIGS. 17A, 17B and 17C are diagrams showing the freezing process and an operation of unloading the substrate after the freezing process in the freezing unit shown in FIG. 14. When the substrate W is placed on the lift pins 96, the control unit 40 controls the pin elevating mechanism 97 to move the lift pins 96 downward. The substrate W is brought closer to the substrate facing surface 92a to be placed on the proximity balls 93. In this way, the underside (frozen film nonforming surface) of the substrate comes into contact with the proximity balls 93 to be supported, and is arranged in proximity to the cooling plate 92 while facing the substrate facing surface 92a with a small clearance of about 1 mm defined between this underside and the substrate facing surface 92a (arranging step). Accordingly, the substrate W is cooled from the underside thereof by the thermal conduction of cold from the substrate facing surface 92a while being supported proximate to the substrate facing surface 92a by the proximity balls 93. As a result, a liquid film 5 adhering to the substrate surface freezes to form a frozen film 7 (Step S13: freezing step).

At this time, even if contaminants such as particles adhere to the substrate surface, the contaminants move away from the substrate surface by marginal distances by the volume expansion of the liquid film 5. In other words, the contaminants separate from the substrate surface by the marginal distances by an increase in the volume of the liquid film having entered space between the substrate surface and the particles. As a result, adhesive forces between the substrate W and the contaminants are weakened, further leading to the separation of the contaminants from the substrate surface.

Here, there are cases where the liquid (DIW) forming the liquid film adheres to a peripheral edge portion of the substrate underside upon loading the substrate W into the freezing unit 20. For example, there is a case where the DIW runs around the peripheral edge portion of the substrate underside and adheres to the substrate underside at the time of forming the liquid film on the substrate surface. Hereinafter, the DIW adhering to the peripheral edge portion of the substrate underside is called “underside adhering liquid”. When the substrate W is arranged in proximity to the cooling plate 92 while underside adhering liquid 5a is adhering to the substrate W, the underside adhering liquid 5a is present between the peripheral part 922a of the substrate facing surface 92a and the peripheral edge portion of the substrate underside (FIG. 17A). As a result, the underside adhering liquid 5a freezes together with the liquid film 5 by the thermal conduction of cold from the substrate facing surface 92a (FIG. 17B). Here, frozen underside adhering liquid 7a adheres to the substrate W with a relative large adhesive force. On the other hand, since the peripheral part 922a is made of a water-repellant material, the wetting angle (contact angle) of the underside adhering liquid 5a to the peripheral part 922a is larger than the one to the substrate W. Accordingly, the adhesive force of the frozen underside adhering liquid 7a to the peripheral part 922a can be reduced. Therefore, the strong adhesion of the cooling plate 92 and the substrate W via the frozen underside adhering liquid 7a can be prevented.

When the freezing of the liquid film is completed in this way, the control unit 40 controls the pin elevating mechanism 97 to move the lift pins 96 upward to the substrate transferring height. At this time, the frozen underside adhering liquid 7a is moved upward together with the substrate W while adhering to the substrate W (FIG. 17C). Thus, the frozen underside adhering liquid 7a can be prevented from remaining on the substrate facing surface 92a. When the lift pins 96 are brought to the substrate transferring height, the substrate W is transferred to the transporting mechanism 30 through the substrate transit port 99. Thereafter, the substrate W subjected to the freezing process is unloaded from the freezing unit 20 by the transporting mechanism 30 and transported to the wet processing unit 10 (Step S14: unloading step).

When the substrate W subjected to the freezing process is loaded into the wet processing unit 10, the substrate W is held by the spin chuck 71. Thereafter, the blocking member 81 is positioned at the facing position. And, with the substrate W held between the base member 711 and the blocking member 81, the control unit 40 starts driving the motors 73 and 83 to rotate both the spin chuck 71 and the blocking member 81. Further, the valves 78 and 88 are opened to supply the inert gas to the substrate W and the space between the base member 71 and the blocking member 81. After the surrounding atmosphere of the substrate W is changed to inert gas atmosphere, the valves 76 and 86 are opened to pressure feed the DIW (corresponding to “post-processing liquid” of the present invention) as rinsing liquid to the nozzles 74 and 84. In this way, the supply of the DIW to both principal surfaces of the substrate W being rotated is started to perform a rinsing process using the DIW. As a result, the frozen film containing particles is melted and removed from the substrate surface (Step S15). In other words, the particles can be easily removed from the substrate surface by removing the frozen film from the substrate surface since the particles adhere to the substrate surface with weakened adhesive forces or separated from the substrate surface.

Upon completing the rinsing process, the valves 76 and 86 are closed to stop the supply of the DIW. Subsequently, the control unit 40 causes the substrate W and the blocking member 81 to rotate at high speed by increasing the rotating speeds of the motors 73 and 83. In this way, the substrate W is dried (spin-dried) (Step S16). After completing the drying of the substrate W, the rotations of the substrate W and the blocking member 81 are stopped and the valves 78 and 88 are closed to stop the supply of the inert gas. In this state, the substrate W is unloaded from the wet processing unit 10 by the transporting mechanism 30 to end a series of cleaning processes.

As described above, according to this embodiment, out of the substrate facing surface 92a facing the substrate underside (frozen film nonforming surface), at least the peripheral part 922a facing the peripheral edge portion of the substrate underside is made of a water-repellent material repelling the liquid (DIW) forming the liquid film. Hence, upon freezing the liquid film formed on the substrate surface using the cooling plate 92 arranged in the freezing unit 20, even in the case where the underside adhering liquid (DIW) is adhering to the peripheral edge portion of the substrate underside, the strong adhesion of the cooling plate 92 and the substrate W via the underside adhering liquid frozen by being cooled can be suppressed. Therefore, the substrate W subjected to the freezing process can be securely unloaded without causing any unloading error upon being unloaded from the freezing unit 20.

### Third Embodiment

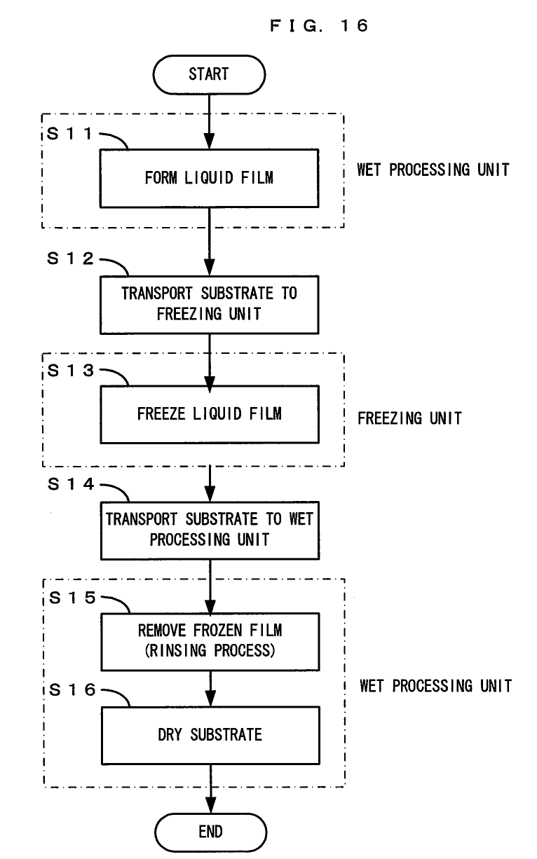

FIG. 18 is a diagram showing a construction of a freezing unit equipped in a substrate processing apparatus according to a third embodiment. This freezing unit 2A equipped in the substrate processing apparatus of the third embodiment largely differs from the freezing unit 20 equipped in the substrate processing apparatus of the second embodiment in that not only the peripheral part of the substrate facing surface of the cooling plate, but the entirety thereof including a central part is made of water-repellent material. The other construction and operation are identified by the same reference numerals and not described here since they are similar to those of the freezing unit 20 equipped in the substrate processing apparatus of the second embodiment. Further, except for the point that the freezing unit 20 is replaced by the freezing unit 2A, the construction and operation of the substrate processing apparatus are basically similar to the construction of the substrate processing apparatus shown in FIG. 11 and the operation of the substrate processing apparatus shown in FIG. 16.

In this embodiment, a cooling plate 92A includes a disc-shaped base portion 923 having a surface to face a substrate underside (frozen film nonforming surface), and a thin film layer 924 covering the entire surface of the base portion 923. The base portion 923 is made of metal such as aluminum, whereas the thin film layer 924 is coated with water-repellent material having a water-repellent property to liquid (DIW) forming a liquid film. The base portion 923 is formed to have a size equal to or slightly larger than that of a substrate in plan view. Thus, a thin film layer surface (substrate facing surface) 924a faces the entire substrate underside by covering the entire surface of the base portion 923 by the thin film layer 924. By cooling the base portion 923, cold is conducted to the substrate underside via the thin film layer 924. According to such a construction, the heat capacity of the cooling plate 92A can be made uniform in a surface of the substrate underside. Therefore, temperature uniformity within the substrate underside can be improved. As a result, the liquid film formed on the substrate surface can be uniformly frozen.

As described above, according to this embodiment, the entire surface of the base portion 923 facing the substrate underside is covered by the thin film layer 924 coated with the water-repellent material. Thus, even in the case where underside adhering liquid (DIW) is adhering to the substrate underside, the strong adhesion of the cooling plate 92A and the substrate W via the underside adhering liquid frozen by being cooled can be suppressed for the same reason as in the second embodiment. Therefore, the substrate W subjected to the freezing process can be securely unloaded without causing any unloading error upon being unloaded from the freezing unit 2A.

### Fourth Embodiment

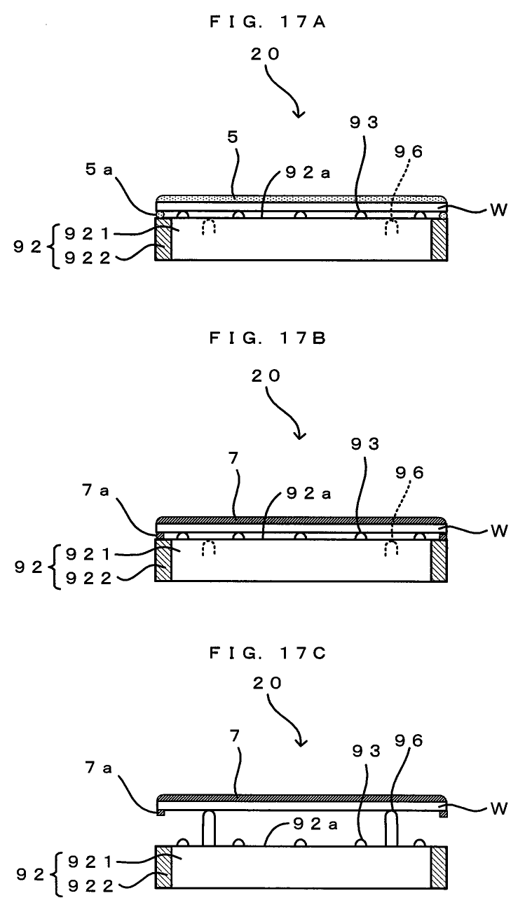

FIG. 19 is a diagram showing a construction of a freezing unit equipped in a substrate processing apparatus according to a fourth embodiment. This freezing unit 2B equipped in the substrate processing apparatus of the fourth embodiment largely differs from the freezing unit 20 equipped in the substrate processing apparatus of the second embodiment in that a freezing process can be collectively applied to a plurality of substrates W. Further, except for the point that the freezing unit 20 is replaced by the freezing unit 2B, the construction and operation of the substrate processing apparatus are basically similar to the construction of the substrate processing apparatus shown in FIG. 11 and the operation of the substrate processing apparatus shown in FIG. 16.

This freezing unit 2B includes a cooling chamber 501. Inside the cooling chamber 501, a processing space PS1 capable of accommodating a plurality of substrates W is formed. The cooling chamber 501 accommodates the substrates W while holding them in substantially horizontal posture. Specifically, the substrates W are held by a boat 502 while being spaced apart from each other and stacked. The boat 502 is placed on a support table 503 disposed at the bottom of the cooling chamber 501. This boat 502 includes a plurality of, e.g. three vertically extending substrate holding posts (corresponding to a “holder” of the present invention) 521 which hold the substrates W, and ring-shaped supporting plates 522 coupled to the top and bottom ends of the three substrate holding posts 521 respectively to fix them. A door (not shown) is provided at a side surface of the cooling chamber 501, so that the substrates W can be loaded and unloaded one by one into and from the cooling chamber 501 by means of the transporting mechanism 30 when the door is opened.

An inner wall surface 511 of the cooling chamber 501 serves as a cooling surface which cools the processing space PS1, and a refrigerant path 504 is so formed along the inner wall surface 511 as to surround the processing space PS1. The opposite ends of this refrigerant path 504 are connected to a refrigerant supplier 505. The refrigerant supplier 505 includes a cooling mechanism which cools refrigerant and a pumping mechanism such as a pump which pressure-feeds the refrigerant to the refrigerant path 504 to circulate it in the refrigerant path 504. Thus, the refrigerant is supplied from the refrigerant supplier 505 and the one having come out of the refrigerant path 504 is returned to the refrigerant supplier 505 again. Any refrigerant may be used provided that it can cool the processing space PS1 below the freezing point (ice point) of liquid via the inner wall surface 511. In this embodiment, since the liquid film is made of DIW, the temperature of the processing space PS1 is set at a temperature below the freezing point (ice point) of DIW. Further, the outer wall of the cooling chamber 501 is covered by a heat insulating material 506 in order to improve the cooling efficiency of the processing space PS1. Thus, the refrigerant path 504 and the refrigerant supplier 505 function as a “freezing unit” of the present invention in this embodiment.

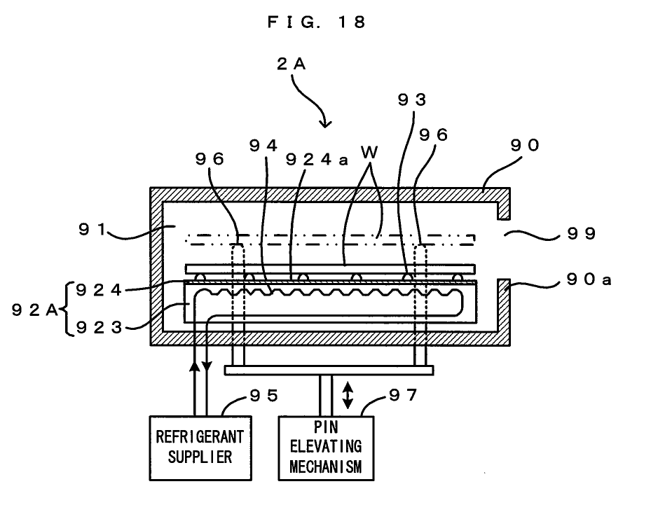

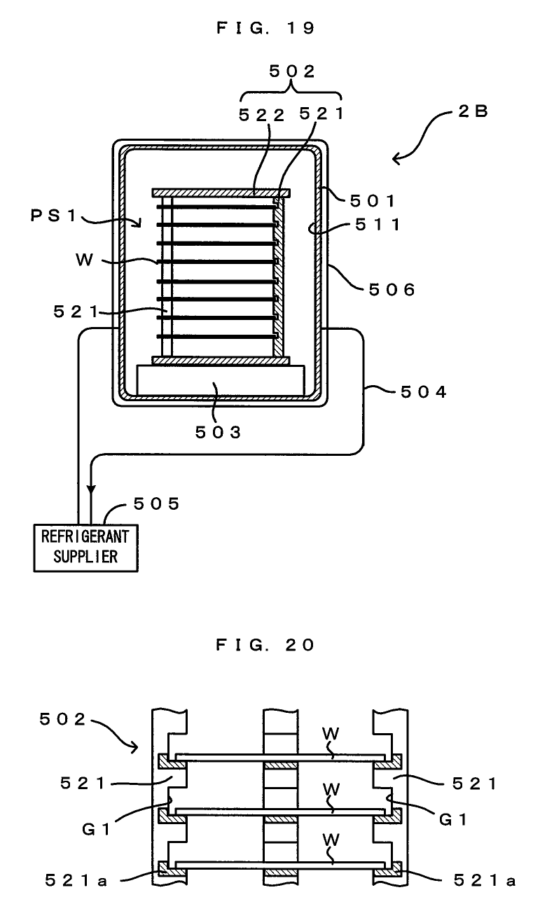

FIG. 20 is a partial enlarged diagram of the boat equipped in the freezing unit shown in FIG. 19. In order to hold the substrates W such that the surface of the substrates W is orthogonal to the longitudinal direction (vertical direction) of the three substrate holding posts 521, in each of the substrate holding posts 521 disposed in the boat 502, a plurality of notch-shaped holding grooves G1 which engage with parts of peripheral edge portions of the substrates W are formed in an arrangement with specified intervals in-between in the longitudinal direction thereof. Thus, each substrate W is held in substantially horizontal posture by being inserted into three holding grooves G1 formed in the respective three substrate holding posts 521 and present at the same height position. At this time, the substrate W is held by the engagement of a peripheral edge portion of the underside (frozen film nonforming surface) of the substrate W with the respective holding grooves G1. Contact parts 521a of each substrate holding post 521 forming parts of the holding grooves G1 and to be kept in contact with the substrates W are made of water-repellent material having a water-repellent property to the liquid (DIW) forming the liquid film.

In this embodiment, when the substrate W is loaded into the freezing unit 2B by the transporting mechanism 30 while the liquid film made of DIW is adhering to the substrate surface, the substrate W is inserted into the holding grooves G1 of the substrate holding posts 521. In this way, the substrate W is held by the substrate holding posts 521 in a state that the contact parts 521a and the substrate W are in contact mutually (holding step). The transporting mechanism 30 causes a plurality of substrates W to be held by the substrate holding posts 521 by repeating the loading of the substrate W into the freezing unit 2B a plurality of times. Thereafter, the processing space PS1 is sealed and the temperature of the processing space PS1 is set at a temperature below the ice point. In this way, the liquid film adhering to the surfaces of the respective substrates W freeze (freezing step).

Here, in the case where the liquid (DIW) forming the liquid film has entered spaces between the contact parts 521a and the substrates W, this liquid also freezes. When the liquid having entered the spaces between the contact parts 521a and the substrates W freezes in this way, the frozen liquid adheres to the substrates W with relatively large adhesive forces. On the other hand, since the contact parts 521a are made of water-repellent material, the adhesive force of the frozen liquid to the contact parts 521a can be reduced for the same reason as in the second embodiment. Thus, the strong adhesion of the substrate holding posts 521 and the substrate W via the frozen liquid can be prevented. Therefore, the substrate W subjected to the freezing process can be securely unloaded without causing any unloading error upon being unloaded from the freezing unit 2B (transporting step).

### Fifth Embodiment

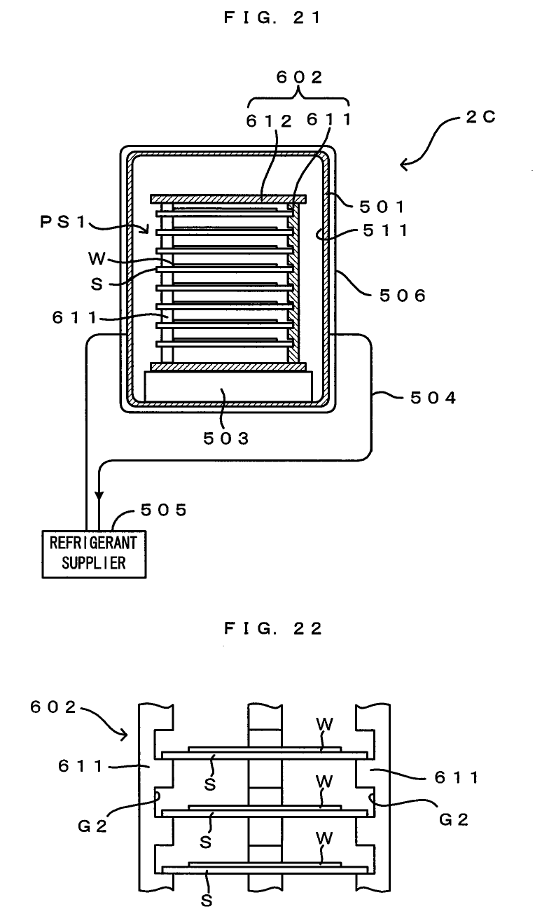

FIG. 21 is a diagram showing a construction of a freezing unit equipped in a substrate processing apparatus according to a fifth embodiment, and FIG. 22 is a partial enlarged diagram of a boat equipped in the freezing unit shown in FIG. 21. This freezing unit 2C equipped in the substrate processing apparatus of the fifth embodiment largely differs from the freezing unit 2B equipped in the substrate processing apparatus of the fourth embodiment in that holders which hold substrates W are constructed to be transportable. The other construction and operation are identified by the same reference numerals and not described here since they are similar to those of the freezing unit 2B equipped in the substrate processing apparatus of the fourth embodiment. Further, except for the point that the freezing unit 20 is replaced by the freezing unit 2C, the construction and operation of the substrate processing apparatus are basically similar to the construction of the substrate processing apparatus shown in FIG. 11 and the operation of the substrate processing apparatus shown in FIG. 16.

In this embodiment, substrates W are transported to the freezing unit 2C while being placed on susceptors (corresponding to a “holder” of the present invention) S. A boat 602 capable of accommodating the substrates W and the susceptors S is placed on a support table 503 in a cooling chamber 501 of the freezing unit 2C. The boat 602 includes a plurality of, e.g. three vertically extending support columns (receptacles) 611 which hold a plurality of susceptors S, and ring-shaped supporting plates 612 coupled to the top and bottom ends of the three support columns 611 respectively to fix them. In each of the support columns 611, a plurality of notch-shaped holding grooves G2 which engage with parts of peripheral edge portions of the susceptors S are formed in an arrangement with specified intervals in-between in the longitudinal direction (vertical direction) thereof in order to hold the susceptors S. Thus, each susceptor S is held in substantially horizontal posture by being inserted into three holding grooves G2 formed in the respective three support columns 611 and present at the same height position.

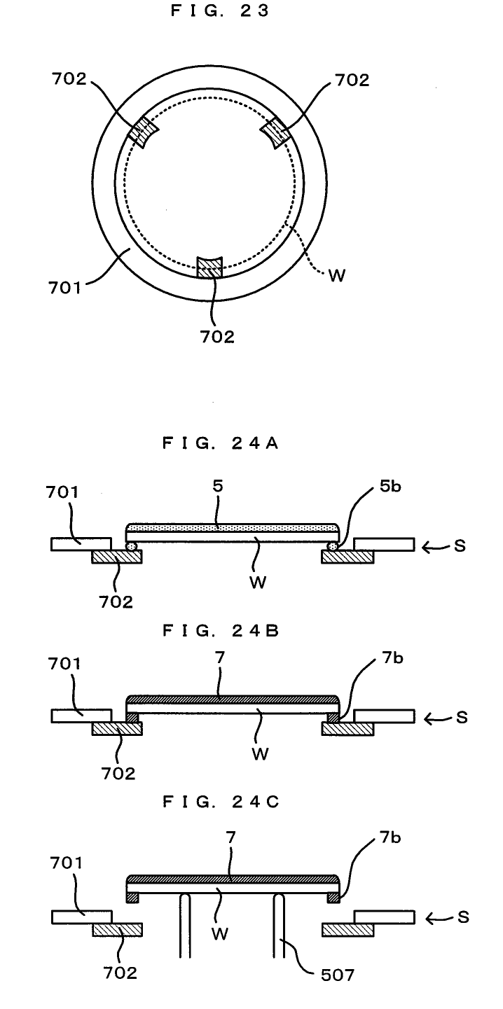

FIG. 23 is a plan view of the susceptor. The susceptor S includes an annular member 701 and a plurality of (three in this embodiment) supporting parts 702 mounted at the bottom of the annular member 701. The diameter of the inner circle of the annular member 701 is set larger than the diameter of the substrate, so that one substrate W can be accommodated inside the annular member 701. A plurality of supporting parts 702 are centered on the center of the annular member 701, are arranged at substantially equal angular intervals and radially extend toward the center of the annular member 701. Thus, when the substrate W is accommodated into the annular member 701, the supporting parts 702 and the substrate W come into contact with each other to support the substrate W on the supporting parts 702. The respective supporting parts 702 are made of water-repellent material having a water-repellent property to liquid (DIW) forming liquid films. Thus, in this embodiment, the supporting parts 702 function as a “contact part” of the present invention. Instead of making the entire supporting parts 702 of water-repellent material, surfaces of the supporting parts 702 may be coated with water-repellent material. Further, each susceptor S (annular member 701+supporting parts 702) may be entirely made of water-repellent material or the surface thereof may be coated with water-repellent material.

FIGS. 24A, 24B and 24C are diagrams showing a freezing process and an operation of unloading the substrate after the freezing process in the freezing unit shown in FIG. 21. The substrate W held by the susceptor S is loaded into the freezing unit 2C while the liquid film (DIW) is adhering to the substrate surface. The susceptor S is then inserted into the holding grooves G2 of the support columns 611, thereby being held by the support columns 611. Here, there are cases where the liquid (DIW) forming a liquid film 5 has entered space between the contact parts 702 and the substrate W (FIG. 24A). Hereinafter, the liquid having entered the space between the supporting parts 702 and the substrate W is called “interposed liquid”. When the temperature of the processing space PS1 of the cooling chamber 501 is set to a temperature below the ice point, interposed liquid 5b freezes together with the liquid film adhering to the substrate surface (FIG. 24B). Frozen interposed liquid 7b adheres to the substrate W with a relatively large adhesive force. On the other hand, since the supporting parts 702 are made of water-repellent material, the adhesive force of the frozen interposed liquid 7b can be reduced for the same reason as in the second embodiment. Therefore, the strong adhesion of the susceptor S and the substrate W via the frozen interposed liquid 7b can be prevented.

When the freezing of the liquid film is completed in this way, the substrate W placed on the susceptor S is unloaded from the freezing unit 2C. In this case, as shown in FIG. 24C, the substrate W may be lifted using lift pins 507 to be separated from the susceptor S. Such lift pins 507 may be, for example, so disposed as to vertically penetrate the support table 503 arranged at the bottom of the cooling chamber 501. When the lift pins 507 move upward, the frozen interposed liquid 7b is separated from the susceptor S together with the substrate W while adhering to the substrate W. Thereafter, the substrate W is transferred from the lift pins 507 to the transporting mechanism 30 and transported to the wet processing unit 10 by the transporting mechanism 30. Accordingly, the substrate W subjected to the freezing process can be securely unloaded without causing any unloading error upon being unloaded from the freezing unit 2C. It should be noted that the transporting mechanism 30 may unload the susceptor S bearing the substrate W subjected to the freezing process from the freezing unit 2C. In this case, the substrate W is transported to the wet processing unit 10 after being separated from the susceptor S outside the freezing unit 2C.

As described above, according to this embodiment, the susceptors S are constructed to be transportable to the support columns 611 capable of accommodating a plurality of substrates W while holding the substrates W one by one. Thus, only the susceptors S or only the contact parts (supporting parts 702) where the susceptors S and the substrates W are in contact may be processed to have a water-repellent property to the liquid (DIW) forming the liquid films, and hence, the cost of processing can be reduced and the processing can be easier. Specifically, in the case where the substrates W are brought into contact with the support columns 611 as holders to be held thereby, it is necessary to make the entire support columns 611 of water-repellent material or all the contact parts of the support columns 611 to be kept in contact with the substrates W of water-repellent material. In such cases, cost required for the processing increases and the processing becomes complicated. Contrary to this, according to this embodiment, it is sufficient to make the susceptors S each holding only one substrate of water-repellent material or to make only the contact parts (supporting parts 702) of the susceptors S to be kept in contact with the substrates W of liquid-repellent material. Therefore, the cost of processing can be reduced and the processing becomes easier.

### Modification to Second through Fifth Embodiments

The present invention is not limited to the above second to fifth embodiments, and various other modifications can be made without departing from the spirit of the present invention. For example, although the liquid films are formed on the substrates W using DIW in the above second to fifth embodiments, liquid films may be formed using a rinsing liquid such as carbonated water, hydrogen water, diluted ammonia water (e.g. about 1 ppm) or diluted hydrochloric acid besides DIW. Besides the rinsing liquid, chemical liquids may be used to form liquid films. In this case, the peripheral parts of the substrate facing surfaces to face the peripheral edge portions of the other principle surfaces (frozen film nonforming surfaces) of the substrates or the contact parts of the holders to be kept in contact with the substrates may be made of liquid-repellent material having a liquid-repellent property to the chemical liquids.

Further, although the particles are removed from the substrate surface together with the liquid film by supplying DIW as post-processing liquid after the freezing of the liquid film to apply the rinsing process to the substrate W in the above second to fifth embodiments, the post-processing liquid is not limited to DIW. For example, the rinsing process may be performed using carbonated water, hydrogen water, diluted ammonia water (e.g. about 1 ppm) or diluted hydrochloric acid. In addition, a chemical liquid process may be performed using chemical liquid such as SC1 solution (mixed solution of ammonia, hydrogen peroxide, and water) as post-processing liquid before the rinsing process is performed.

The present invention is applicable to a substrate processing apparatus and a substrate processing method for cleaning substrates in general including semiconductor wafers, glass substrates for photomasks, glass substrates for liquid crystal displays, glass substrates for plasma displays and substrates for optical disks.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is claimed is:

1. A substrate processing apparatus which cleans a substrate, comprising:
a preprocessing unit which supplies preprocessing liquid to the substrate and forms a liquid film of the preprocessing liquid on a surface-to-be-processed of the substrate,
a freezing unit which includes a processing chamber in which a processing space capable of accommodating the substrate is formed and freezes the liquid film formed on the surface-to-be-processed of the substrate by decreasing a temperature of the processing space to a temperature below the freezing point of the preprocessing liquid,
a post-processing unit which supplies post-processing liquid to the liquid film after the freezing and removes the liquid film from the surface-to-be-processed of the substrate, and
a transporting section which transports the substrate between the preprocessing unit and the freezing unit and between the freezing unit and the post-processing unit inside the apparatus out of the three processing units arranged separately from each other inside the apparatus.

2. The substrate processing apparatus of claim 1, wherein the preprocessing unit includes a first processing tank which stores the preprocessing liquid, and an immersing and pulling-up section which collectively immerses a plurality of substrates into the preprocessing liquid stored in the first processing tank and then pulls up the plurality of substrates from the preprocessing liquid.

3. The substrate processing apparatus of claim 1, wherein the preprocessing unit includes a first shower nozzle which showers the preprocessing liquid toward surfaces-to-be-processed of a plurality of substrates.

4. The substrate processing apparatus of claim 1, wherein the post-processing unit includes a second shower nozzle which showers the post-processing liquid toward surfaces-to-be-processed of a plurality of substrates.

5. The substrate processing apparatus of claim 4, wherein the post-processing unit further includes a substrate holder which holds the plurality of substrates while separating them from each other, and a rotator which rotates the substrate holder.

6. The substrate processing apparatus of claim 1, wherein the post-processing unit includes:
a second processing tank which stores the post-processing liquid;
a post-processing liquid introducing section which introduces the post-processing liquid into the second processing tank;
an immersing section which collectively immerses a plurality of substrates into the post-processing liquid stored in the second processing tank; and
a bubble generator which generates bubbles in the post-processing liquid stored in the second processing tank, and wherein
the post-processing unit supplies the bubbles generated by the bubble generator toward surfaces-to-be-processed of the plurality of substrates immersed in the post-processing liquid.

7. The substrate processing apparatus of claim 6, wherein the bubble generator includes a gas supplier which supplies gas into the post-processing liquid stored in the second processing tank to let the gas bubble in the post-processing liquid.

8. The substrate processing apparatus of claim 6, wherein the bubble generator includes a gas dissolver which dissolves the gas supersaturatedly into the post-processing liquid introduced into the second processing tank by the post-processing liquid introducing section.

9. A substrate processing method for cleaning a substrate, comprising:
a liquid film forming step of applying preprocessing liquid to a surface-to-be-processed of the substrate to form a liquid film of the preprocessing liquid in a preprocessing unit;
a first transporting step of transporting the substrate on which the liquid film of the preprocessing liquid is formed to a freezing unit which is arranged separately from the preprocessing unit and which includes a processing chamber in which a processing space capable of accommodating the substrate is formed;
a freezing step of freezing the liquid film by decreasing a temperature of the processing space to a temperature below the freezing point of the preprocessing liquid in the freezing unit;
a second transporting step of transporting the substrate having the liquid film frozen in the freezing unit to a post-processing unit arranged separately from the freezing unit; and
a film removal step of removing the frozen film by supplying post-processing liquid to the surface-to-be-processed of the substrate in the post-processing unit.

10. The substrate processing method of claim 9, wherein
the preprocessing liquid is supplied simultaneously to a plurality of substrates to collectively form liquid films on surfaces-to-be-processed of the plurality of substrates in the liquid film forming step, and
the post-processing liquid is supplied simultaneously to the plurality of substrates to remove the liquid films after the freezing from the respective surfaces-to-be-processed of the plurality of substrates in the film removal step.

11. The substrate processing method of claim 9, wherein the substrate is transported from the preprocessing unit to the freezing unit before the liquid film formed on the surface-to-be-processed of the substrate dries in the first transporting step.

12. The substrate processing method of claim 9, wherein the substrate is transported from the freezing unit to the post-processing unit before the liquid film after the freezing melts in the second transporting step.

13. The substrate processing apparatus of claim 1, wherein
the freezing unit includes a holder which has a contact part that can be brought into contact with the substrate and holds the substrate by bringing the contact part and the substrate into contact with each other with the liquid film formed on the surface-to-be-processed of the substrate, and a freezer which freezes the liquid film, and wherein
the contact part is made of liquid-repellent material having a liquid-repellent property to the liquid.

14. The substrate processing apparatus of claim 13, wherein the liquid forming the liquid film is water and the liquid-repellent material is fluororesin.
